(19) United States
(12) Patent Application Publication
(10) Pub. No.: US 2009/0165938 A1
(43) Pub. Date: Jul. 2, 2009

(54) METHOD OF FORMING IMAGE BY HEAT-SENSITIVE TRANSFER SYSTEM

(75) Inventors: Naotsugu MURO, Minami-ashigara-shi (JP); Hisato Nagase, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/341,465

(22) Filed: Dec. 22, 2008

(30) Foreign Application Priority Data
Dec. 28, 2007 (JP) 2007-339892

(51) Int. Cl. B32B 37/02; B32B 37/30

(52) U.S. Cl. 156/230

(57) ABSTRACT

A method of producing an image, having superposing an ink sheet on an image-receiving sheet, and applying thermal energy,
wherein the ink sheet comprises a yellow, magenta and cyan dye layers each containing at least one kind of each of yellow, magenta or cyan dye represented by formulae (1), (2) or (3); and wherein a receptor layer of the image-receiving sheet contains a latex polymer;

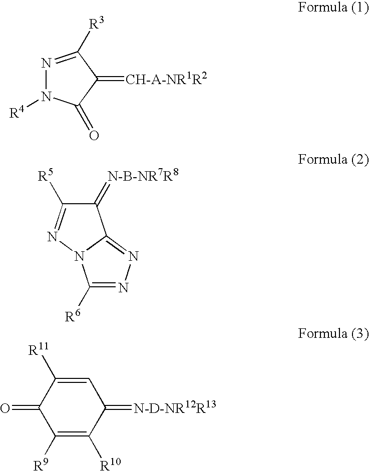

wherein A is a phenylene; R¹ and R² are a hydrogen, or an alkyl, alkenyl or aryl; R³ is a hydrogen, or an alkyl, aryl, amino, alkoxy, aryloxy, alkoxycarbonyl, aryloxycarbonyl or carbamoyl; R⁴ is an alkyl or aryl; B is a phenylene or pyridine ring; R⁵, R⁶, R⁷, R⁸, R¹² and R¹³ are an alkyl, alkenyl or aryl; D is a phenylene; R⁹ is a hydrogen or halogen; R¹⁰ is an alkyl; and R¹¹ is an acylamino or alkoxycarbonylamino.

### FIELD OF THE INVENTION

The present invention relates to a method of forming an image by heat-sensitive transfer system.

### BACKGROUND OF THE INVENTION

Various heat transfer recording methods have been known so far. Among these methods, sublimation type transfer recording systems attract attention as a process that can produce a color hard copy having an image quality closest to that of silver halide photography. Moreover, this system has advantages over silver halide photography: it is a dry system, it enables direct visualization from digital data, it makes reproduction simple, and the like.

In the sublimation type thermal transfer recording systems, a colorant (hereinafter also referred to as “dye”)-containing heat-sensitive transfer sheet (hereinafter also simply referred to as “an ink sheet”) and a heat-sensitive transfer image-receiving sheet (hereinafter also simply referred to as “an image-receiving sheet”) are superposed, and the heat-sensitive transfer sheet is heated using a thermal head with which heat generation can be controlled by electric signals. Thereby a dye in the heat-sensitive transfer sheet is transferred to the image-receiving sheet to record image information. More specifically, a transferred color image with a continuous change in color shading can be obtained by recording three colors including cyan, magenta and yellow, or four colors including black in addition to the three colors in the manner of one over another.

Important conditions required for the materials used in the system include the ability to produce high transfer density, the ability to maintain high density and good color balance after light irradiation or after storage at a high temperature in dark place for certain time, and the like. In order to bring out such features, various efforts have been made on both the heat-sensitive transfer sheet and the heat-sensitive transfer image-receiving sheet.

For the heat-sensitive transfer sheet, for example, a certain combination of yellow, magenta and cyan dyes is proposed (see, for example, JP-A-2003-205686 (“JP-A” means unexamined published Japanese patent application)). On the other hand, it is proposed that a heat insulation layer using hollow particles and an aqueous coating liquid is employed for the heat-sensitive transfer image-receiving sheet (see, for example, JP-A-2006-88691 and JP-A-2006-264087).

However, in terms of achieving both high density and good color balance after storage at high temperatures in dark place for certain time, which is one of important capabilities required for prints after transfer, such conventional techniques are still insufficient to satisfy the users' requirements.

### SUMMARY OF THE INVENTION

The present invention resides in a method of producing an image, comprising the steps of:

superposing a heat-sensitive transfer sheet on a heat-sensitive transfer image-receiving sheet so that a heat-sensitive transfer layer of the heat-sensitive transfer sheet is in contact with a receptor layer of the heat-sensitive transfer image-receiving sheet, and

applying thermal energy in accordance with an image signal, to form a thermally transferred image,

wherein the heat-sensitive transfer sheet comprises, on a support, a yellow dye layer which contains at least one kind of yellow dye represented by formula (1), a magenta dye layer which contains at least one kind of magenta dye represented by formula (2), and a cyan dye layer which contains at least one kind of cyan dye represented by formula (3); and
wherein the receptor layer on a support of the heat-sensitive transfer image-receiving sheet contains a latex polymer;

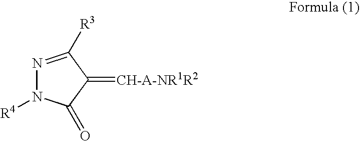

wherein A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted alkyl group, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group;

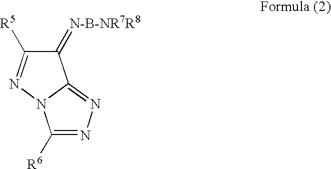

wherein B represents a substituted or unsubstituted phenylene group or a substituted or unsubstituted divalent pyridine ring group; and R⁵, R⁶, R⁷ and R⁸ each independently represent a substituted or unsubstituted alkyl group, a substituted or unsubstituted alkenyl group or a substituted or unsubstituted aryl group; and

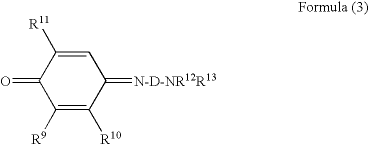

wherein D represents a substituted or unsubstituted phenylene group; R⁹ represents a hydrogen atom or a halogen atom; R¹⁰ represents a substituted or unsubstituted alkyl group; R¹¹ represents a substituted or unsubstituted acylamino group or a substituted or unsubstituted alkoxycarbonylamino group; and R¹² and R¹³ each independently represent a substituted or unsubstituted alkyl group, a substituted or unsubstituted alkenyl group or a substituted or unsubstituted aryl group.

Other and further features and advantages of the invention will appear more fully from the following description.

### DETAILED DESCRIPTION OF THE INVENTION

According to the present invention, there is provided the following means:
(1) A method of producing an image, comprising the steps of:

superposing a heat-sensitive transfer sheet on a heat-sensitive transfer image-receiving sheet so that a heat-sensitive transfer layer of the heat-sensitive transfer sheet is in contact with a receptor layer of the heat-sensitive transfer image-receiving sheet, and

applying thermal energy in accordance with an image signal, to form a thermally transferred image,

wherein the heat-sensitive transfer sheet comprises, on a support, a yellow dye layer which contains at least one kind of yellow dye represented by formula (1), a magenta dye layer which contains at least one kind of magenta dye represented by formula (2), and a cyan dye layer which contains at least one kind of cyan dye represented by formula (3); and
wherein the receptor layer on a support of the heat-sensitive transfer image-receiving sheet contains a latex polymer;

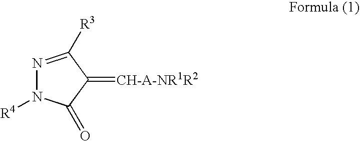

wherein A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted alkyl group, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group;

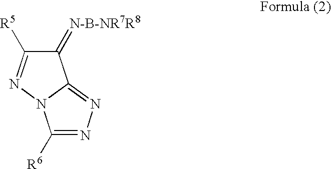

wherein B represents a substituted or unsubstituted phenylene group or a substituted or unsubstituted divalent pyridine ring group; and R⁵, R⁶, R⁷ and R⁸ each independently represent a substituted or unsubstituted alkyl group, a substituted or unsubstituted alkenyl group or a substituted or unsubstituted aryl group; and

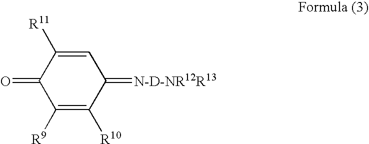

wherein D represents a substituted or unsubstituted phenylene group; R⁹ represents a hydrogen atom or a halogen atom; R¹⁰ represents a substituted or unsubstituted alkyl group; R¹¹ represents a substituted or unsubstituted acylamino group or a substituted or unsubstituted alkoxycarbonylamino group; and R¹² and R¹³ each independently represent a substituted or unsubstituted alkyl group, a substituted or unsubstituted alkenyl group or a substituted or unsubstituted aryl group.
(2) The method of producing an image as described in the above item (1), wherein the heat-sensitive transfer image-receiving sheet further comprises at least one heat insulation layer that contains hollow polymer particles between the support and the receptor layer.
(3) The method of producing an image as described in the above item (2), wherein the hollow polymer particles are latex hollow polymer particles.
(4) The method of producing an image as described in the above item (2) or (3), wherein the heat insulation layer and the receptor layer of the heat-sensitive transfer image-receiving sheet are formed by simultaneous multilayer coating.
(5) The method of producing an image as described in any one of the above items (1) to (4), wherein R¹, R², R⁷, R⁸, R¹² and R¹³ each independently represent an unsubstituted alkyl group; R³ represents an unsubstituted alkoxy group; R⁴ represents an unsubstituted aryl group; R⁵ represents a substituted or unsubstituted alkyl group; R⁶ represents a substituted or unsubstituted aryl group; R⁹ represents a halogen atom; R¹⁰ represents an unsubstituted alkyl group; R¹¹ represents an unsubstituted acyl group; A represents an unsubstituted phenylene group; B represents a substituted or unsubstituted divalent pyridine ring group; and D represents an unsubstituted phenylene group.
(6) The method of producing an image as described in any one of the above items (1) to (5),
   wherein the heat-sensitive transfer sheet further comprises a back side layer on the surface of the support opposite to the yellow, magenta and cyan dye layers, and wherein the back side layer comprises an acrylic resin.
(7) The method of producing an image as described in the above item (6), wherein the acrylic resin of the back side layer is an acrylic polyol resin.
(8) The method of producing an image as described in any one of the above items (1) to (7), wherein each of the dye layers comprises a matting agent.
(9) The method of producing an image as described in any one of the above items (1) to (8),
   wherein the receptor layer comprises at least two kinds of latex polymers, and wherein each of the two kinds of the latex polymers is a polyvinylchloride series latex polymer.

First, the heat-sensitive transfer sheet for use in the present invention is explained in detail below.

### (Dye Layer)

In the dye layer of the present invention, preferably, dye layers in individual colors of yellow, magenta and cyan, and an optional dye layer in black are repeatedly painted onto a single support in area order in such a manner that the colors are divided from each other, according to need. As an example, there can be exemplified an embodiment wherein dye layers in individual colors of yellow, magenta and cyan are painted onto a single support along the long axial direction thereof in area order, in accordance with the area of the recording surface of the above-mentioned heat-sensitive transfer image-receiving sheet, in such a manner that the colors are divided from each other. Another example thereof is an embodiment wherein not only the three layers but also a dye layer in black and/or a transferable protective layer are painted in such a manner that these layers are divided from each other. This embodiment is preferred.

In the case of adopting such an embodiment, it is one of preferred embodiments to mark the heat-sensitive transfer sheet in order to inform the printer of starting point of the individual colors. Such repeated painting in area order, in a manner that the colors are divided from each other, enables to form an image on the basis of transfer of dyes and further laminate a protective layer on the image by a single heat-sensitive transfer sheet.

In the invention, however, the manner in which the dye layer is formed is not limited to the above-mentioned manners. A sublimation type thermal transfer ink layer (a dye layer) and a heat-melt transfer ink layer may be together formed. Further, other modifications, such as forming a dye layer in a color other than yellow, magenta, cyan and black, are possible. The form of the heat-sensitive transfer sheet including the dye layer may be a longitudinal form, or a one-piece form.

The dye layers of each color may have a mono-layered structure or a multi-layered structure. In the case of the multi-layered structure, the individual layers constituting the dye layer may be the same or different in composition.

### (Dye Ink)

The dye layer contains a dye. The dye layer generally contains at least a sublimation type dye (dye) and a binder. The dye layer may further contain a release agent and a matting agent such as waxes, silicone resins, and fluorine-containing organic compounds, according to need. As the release agent, silicone release agents are preferable. Among the silicone release agents, an amino-modified or epoxy-modified silicone is particularly preferable. Examples of the amino-modified silicone include TSF4701 (trade name, manufactured by MOMENTIVE Performance Materials Japan LLC.) and the like. Examples of the epoxy-modified silicone include X22-3000T (trade name, manufactured by Shin-Etsu Chemical Co., Ltd.) and the like. It is also preferable to contain two or more kinds of these release agents in the dye layer. As the matting agent, a matting agent made of polyethylene fine particles is preferable, and examples thereof include Flo-thene UF (trade name, manufactured by Sumitomo Seika Chemicals Co., Ltd.) and the like.

Each dye in the dye layer is preferably contained in an amount of 10 to 90 mass %, more preferably 20 to 80 mass %, furthermore preferably 20 to 60 mass %, and most preferably 20 to 50 mass % with respect to the dye layer, respectively.

The coating of the dye layer (i.e., the painting of a coating liquid for the dye layer) is performed by an ordinary method such as roll coating, bar coating, gravure coating, or gravure reverse coating. The coating amount of the dye layer is preferably from 0.1 to 2.0 g/m², more preferably from 0.2 to 1.2 g/m² (the amount is a numerical value converted to the solid content in the layer; any coating amount in the following description is a numerical value converted to the solid content unless otherwise specified). The film thickness of the dye layer is preferably from 0.1 to 2.0 μm, more preferably from 0.2 to 1.2 μm.

Next, each of the dyes represented by formulae (1) to (3) for use in the present invention is explained in detail below.

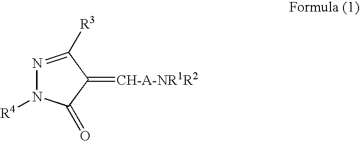

In formula (1), A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted alkyl group, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group.

Hereinafter, the substituents which the groups represented by A, R¹, R², R³, and R⁴ may have will be more specifically described.

Hereinafter, such substituents will be illustrated below with reference to typical and preferred examples thereof. Any of such substituents is a substituent which each of the above groups may have. The groups B and R⁵, R⁶, R⁷ and R⁸ in formula (2) below may also have any of such substituents, and the groups R⁹, R¹⁰, R¹¹ and R¹² in formula (3) may also have any of such substituents.

The substituent that the groups represented by A, R¹, R², R³, and R⁴ may have is not particularly limited. Examples thereof include a halogen atom, an aliphatic group, an aryl group, a heterocyclic group, an aliphatic oxy group, an aryloxy group, an acyloxy group, a carbamoyloxy group, an aliphatic oxy carbonyloxy group, an aryloxycarbonyloxy group, an amino group, an acylamino group, an aminocarbonylamino group, an aliphatic oxy carbonylamino group, an aryloxycarbonylamino group, a sulfamoylamino group, an aliphatic- or aryl-sulfonylamino group, an aliphatic thio group, a sulfamoyl group, an aliphatic- or aryl-sulfinyl group, an aliphatic- or aryl-sulfonyl group, an acyl group, an aryloxycarbonyl group, an aliphatic oxy carbonyl group, a carbamoyl group, an aryl- or heterocyclic-azo group, an imido group, a hydroxyl group, a cyano group, a nitro group, a sulfo group and a carboxyl group.

The halogen atom that A, R¹, R², R³, and R⁴ may have includes a fluorine atom, a chlorine atom, a bromine atom, and an iodine atom. Of these, a chlorine atom and a bromine atom are preferable, a chlorine atom is particularly preferable.

The aliphatic group that A, R¹, R², R³, and R⁴ may have includes a linear, branched or cyclic aliphatic group. The term “cyclic aliphatic group” means cyclic aliphatic group, such as a cycloalkyl group, a cycloalkenyl group, a cycloalkynyl group, a bicycloalkyl group and the like. The saturated aliphatic group includes an alkyl group, a cycloalkyl group and bicycloalkyl group and these groups may have a substituent. The carbon numbers of these substituents is preferably from 1 to 30. Examples of the alkyl group include a methyl group, an ethyl group, an n-propyl group, an isopropyl group, a t-butyl group, an n-octyl group, an eicosyl group, a 2-chloroethyl group, a 2-cyanoethyl group, a benzyl group or a 2-ethylhexyl group. The cycloalkyl group includes a substituted or unsubstituted cycloalkyl group. The substituted or unsubstituted cycloalkyl group is preferably a cycloalkyl group having 3 to 30 carbon atoms. Examples of the cycloalkyl group include a cyclohexyl group, a cyclopentyl group and a 4-n-dodecylcyclohexyl group. The bicycloalkyl group includes a substituted or unsubstituted bicycloalkyl group having 5 to 30 carbon atoms, i.e., a monovalent group obtained by removing one hydrogen atom from a bicycloalkane having 5 to 30 carbon atoms. Examples of the bicycloalkyl group include a bicyclo[1,2,2]heptan-2-yl group or a bicyclo[2,2,2]octan-3-yl group, and a tricyclo or higher structure having three or more ring structures.

The unsaturated aliphatic group that A, R¹, R², R³, and R⁴ may have represents a linear, branched, or cyclic unsaturated aliphatic group. The unsaturated aliphatic group includes an alkenyl group, a cycloalkenyl group, a bicycloalkenyl group and an alkynyl group. The alkenyl group represents a substituted or unsubstituted alkenyl group having 2 to 30 carbon atoms. Examples of the alkenyl group include a vinyl group, an allyl group, a prenyl group, a geranyl group, or an oleyl group. The cycloalkenyl group is preferably a substituted or unsubstituted cycloalkenyl group having 3 to 30 carbon atoms, i.e., a monovalent group obtained by removing one hydrogen atom from a cycloalkene having 3 to 30 carbon atoms. Examples of the cycloalkenyl group include a 2-cyclopenten-1-yl group or a 2-cyclohexen-1-yl group. The bicycloalkenyl group includes a substituted or unsubstituted bicycloalkenyl group, and preferably a substituted or unsubstituted bicycloalkenyl group having 5 to 30 carbon atoms, i.e., a monovalent group obtained by removing one hydrogen atom from a bicycloalkene having one double bond. Examples of the bicycloalkenyl group include a bicyclo[2,2,1]hept-2-en-1-yl group or a bicyclo[2,2,2]oct-2-en-4-yl group. The alkynyl group is preferably a substituted or unsubstituted alkynyl group having 2 to 30 carbon atoms, e.g., an ethynyl group, or a propargyl group.

The aryl group that A, R¹, R², R³, and R⁴ may have is preferably a substituted or unsubstituted aryl group having 6 to 30 carbon atoms, e.g., a phenyl group, a p-tolyl group, a naphthyl group, an m-chlorophenyl group, or an o-hexadecanoylaminophenyl group. The aryl group is more preferably a substituted or unsubstituted phenyl group.

The heterocyclic group that A, R¹, R², R³, and R⁴ may have, is a monovalent group obtained by removing one hydrogen atom from a substituted or unsubstituted, aromatic or nonaromatic heterocyclic compound, which may be condensed to another ring. The heterocyclic group is preferably a 5- or 6-membered heterocyclic group. The hetero atom(s) constituting the heterocyclic group is preferably an oxygen atom, a sulfur atom, or a nitrogen atom. The heterocyclic group is more preferably a 5- or 6-membered aromatic heterocyclic group having 3 to 30 carbon atoms. The hetero ring in the heterocyclic group are exemplified below: a pyridine ring, a pyrazine ring, a pyridazine ring, a pyrimidine ring, a triazine ring, a quinoline ring, an isoquinoline ring, a quinazoline ring, a cinnoline ring, a phthalazine ring, a quinoxaline ring, a pyrrole ring, an indole ring, a furan ring, a benzofuran ring, a thiophene ring, a benzothiophene ring, a pyrazole ring, an imidazole ring, a benzimidazole ring, a triazole ring, an oxazole ring, a benzoxazole ring, a thiazole ring, a benzothiazole ring, an isothiazole ring, a benzisothiazole ring, a thiadiazole ring, an isoxazole ring, a benzisoxazole ring, a pyrrolidine ring, a piperidine ring, a piperazine ring, an imidazolidine ring and a thiazoline ring.

The aliphatic oxy group (as a representative example, an alkoxy group) that A, R¹, R², R³, and R⁴ may have includes a substituted or unsubstituted aliphatic oxy group (as a representative example, alkoxy group). The substituted or unsubstituted aliphatic oxy group is preferably an aliphatic oxy group having 1 to 30 carbon atoms, e.g., a methoxy group, an ethoxy group, an isopropoxy group, an n-octyloxy group, a methoxyethoxy group, a hydroxyethoxy group, or a 3-carboxypropoxy group.

The aryloxy group that A, R¹, R², R³, and R⁴ may have is preferably a substituted or unsubstituted aryloxy group having 6 to 30 carbon atoms, e.g., a phenoxy group, a 2-methylphenoxy group, a 4-t-butylphenoxy group, a 3-nitrophenoxy group, or a 2-tetradecanoylaminophenoxy group. The aryloxy group is more preferably a phenoxy group which may have a substituent.

The acyloxy group that A, R¹, R², R³, and R⁴ may have is preferably a formyloxy group, a substituted or unsubstituted alkylcarbonyloxy group having 2 to 30 carbon atoms, or a substituted or unsubstituted arylcarbonyloxy group having 7 to 30 carbon atoms, e.g., a formyloxy group, an acetyloxy group, a pivaloyloxy group, a stearoyloxy group, a benzoyloxy group, or a p-methoxyphenylcarbonyloxy group.

The carbamoyloxy group that A, R¹, R², R³, and R⁴ may have is preferably a substituted or unsubstituted carbamoyloxy group having 1 to 30 carbon atoms, e.g., an N,N-dimethylcarbamoyloxy group, an N,N-diethylcarbamoyloxy group, a morpholinocarbonyloxy group, an N,N-di-n-octylaminocarbonyloxy group, or an N-n-octylcarbamoyloxy group.

The aliphatic oxy carbonyloxy group (as a representative example, an alkoxycarbonyloxy group) that A, R¹, R², R³, and R⁴ may have is preferably an aliphatic oxy carbonyloxy group having 2 to 30 carbon atoms. There can be exemplified a methoxycarbonyloxy group, an ethoxycarbonyloxy group, a t-butoxycarbonyloxy group, or an n-octylcarbonyloxy group. The aliphatic oxy carbonyloxy group may have a substituent(s).

The aryloxycarbonyloxy group that A, R¹, R², R³, and R⁴ may have is preferably a substituted or unsubstituted aryloxycarbonyloxy group having 7 to 30 carbon atoms, e.g., a phenoxycarbonyloxy group, a p-methoxyphenoxycarbonyloxy group, or a p-n-hexadecyloxyphenoxycarbonyloxy group. The aryloxycarbonyloxy group is more preferably a substituted or unsubstituted phenoxycarbonyloxy group.

The amino group that A, R¹, R², R³, and R⁴ may have includes an unsubstituted amino group, an aliphatic amino group (as a representative example, an alkylamino group), an arylamino group, and a heterocyclic amino group. The amino group is preferably a substituted or unsubstituted aliphatic amino group (as a representative example, alkylamino group) having 1 to 30 carbon atoms, or a substituted or unsubstituted arylamino group having 6 to 30 carbon atoms, e.g., an amino group, a methylamino group, a dimethylamino group, an anilino group, an N-methyl-anilino group, a diphenylamino group, a hydroxyethylamino group, a carboxyethylamino group, a sulfoethylamino group, a 3,5-dicarboxyanilino group, or a 4-quinolylamino group.

The acylamino group that A, R¹, R², R³, and R⁴ may have is preferably a formylamino group, a substituted or unsubstituted alkylcarbonylamino group having 1 to 30 carbon atoms, or a substituted or unsubstituted arylcarbonylamino group having 7 to 30 carbon atoms, e.g., a formylamino group, an acetylamino group, a pivaloylamino group, a lauroylamino group, a benzoylamino group, or a 3,4,5-tri-n-octyloxyphenylcarbonylamino group.

The aminocarbonylamino group that A, R¹, R², R³, and R⁴ may have is preferably a substituted or unsubstituted aminocarbonylamino group having 1 to 30 carbon atoms, e.g., a carbamoylamino group, an N,N-dimethylaminocarbonylamino group, an N,N-diethylaminocarbonylamino group, or a morpholinocarbonylamino group. In the aminocarbonylamino group, the term “amino” has the same meaning as “amino” in the above-described amino group.

The aliphatic oxy carbonylamino group (as a representative example, alkoxycarbonylamino group) that A, R¹, R², R³, and R⁴ may have is preferably a substituted or unsubstituted aliphatic oxy carbonylamino group having 2 to 30 carbon atoms, e.g., a methoxycarbonylamino group, an ethoxycarbonylamino group, a t-butoxycarbonylamino group, an n-octadecyloxycarbonylamino group, or an N-methyl-methoxycarbonylamino group.

The aryloxycarbonylamino group that A, R¹, R², R³, and R⁴ may have is preferably a substituted or unsubstituted aryloxycarbonylamino group having 7 to 30 carbon atoms, e.g., a phenoxycarbonylamino group, a p-chlorophenoxycarbonylamino group, or an m-n-octyloxyphenoxycarbonylamino group. The aryloxycarbonylamino group is more preferably substituted or unsubstituted phenoxycarbonylamino group.

The sulfamoylamino group that A, R¹, R², R³, and R⁴ may have is preferably a substituted or unsubstituted sulfamoylamino group having 0 to 30 carbon atoms, e.g., a sulfamoylamino group, an N,N-dimethylaminosulfonylamino group, or an N-n-octylaminosulfonylamino group.

The aliphatic- (as a representative example, alkyl-) or aryl-sulfonylamino group that A, R¹, R², R³, and R⁴ may have is preferably a substituted or unsubstituted aliphatic sulfonylamino group (as a representative example, alkylsulfonylamino group) having 1 to 30 carbon atoms, or a substituted or unsubstituted arylsulfonylamino group having 6 to 30 carbon atoms, e.g., a methylsulfonylamino group, a butylsulfonylamino group, a phenylsulfonylamino group, a 2,3,5-trichlorophenylsulfonylamino group, or a p-methylphenylsulfonylamino group.

The aliphatic thio group (as a representative example, alkylthio group) that A, R¹, R², R³, and R⁴ may have is preferably a substituted or unsubstituted alkylthio group having 1 to 30 carbon atoms, e.g., a methylthio group, an ethylthio group, or an n-hexadecylthio group.

The sulfamoyl group that A, R¹, R², R³, and R⁴ may have is preferably a substituted or unsubstituted sulfamoyl group having 0 to 30 carbon atoms, e.g., an N-ethylsulfamoyl group, an N-(3-dodecyloxypropyl)sulfamoyl group, an N,N-dimethylsulfamoyl group, an N-acetylsulfamoyl group, an N-benzoylsulfamoly group, or an N-(N′-phenylcarbamoyl)sulfamoyl group.

The aliphatic- (as a representative example, alkyl-) or aryl-sulfinyl group that A, R¹, R², R³, and R⁴ may have is preferably a substituted or unsubstituted alkylsulfinyl group having 1 to 30 carbon atoms, or a substituted or unsubstituted arylsulfinyl group (preferably a substituted or unsubstituted phenylsulfinyl group) having 6 to 30 carbon atoms, e.g., a methylsulfinyl group, an ethylsulfinyl group, a phenylsulfinyl group, or a p-methylphenylsulfinyl group.

The aliphatic- (as a representative example, alkyl-) or aryl-sulfonyl group that A, R¹, R², R³, and R⁴ may have is preferably a substituted or unsubstituted aliphatic-sulfonyl group (as a representative example, alkylsulfonyl group) having 1 to 30 carbon atoms, or a substituted or unsubstituted arylsulfonyl group (preferably a substituted or unsubstituted phenylsulfonyl group) having 6 to 30 carbon atoms, e.g., a methylsulfonyl group, an ethylsulfonyl group, a phenylsulfonyl group, or a p-toluenesulfonyl group.

The acyl group that A, R¹, R², R³, and R⁴ may have is preferably a formyl group, a substituted or unsubstituted aliphatic carbonyl group (as a representative example, alkylcarbonyl group) having 2 to 30 carbon atoms, a substituted or unsubstituted arylcarbonyl group (preferably a substituted or unsubstituted phenylcarbonyl group) having 7 to 30 carbon atoms, or a substituted or unsubstituted heterocyclic carbonyl group having 4 to 30 carbon atoms and being bonded to said carbonyl group through a carbon atom, e.g., an acetyl group, a pivaloyl group, a 2-chloroacetyl group, a stearoyl group, a benzoyl group, a p-n-octyloxyphenylcarbonyl group, a 2-pyridylcarbonyl group, or a 2-furylcarbonyl group.

The aryloxycarbonyl group that A, R¹, R², R³, and R⁴ may have is preferably a substituted or unsubstituted aryloxycarbonyl group having 7 to 30 carbon atoms, e.g., a phenoxycarbonyl group, an o-chlorophenoxycarbonyl group, an m-nitrophenoxycarbonyl group, or a p-t-butylphenoxycarbonyl group. The aryloxycarbonyl group is more preferably a substituted or unsubstituted phenoxycarbonyl group.

The aliphatic oxycarbonyl group (as a representative example, alkoxycarbonyl group) that A, R¹, R², R³, and R⁴ may have is preferably a substituted or unsubstituted aliphatic oxycarbonyl group having 2 to 30 carbon atoms, e.g., a methoxycarbonyl group, an ethoxycarbonyl group, a t-butoxycarbonyl group, or an n-octadecyloxycarbonyl group. The aliphatic oxycarbonyl group may have a substituent(s).

The carbamoyl group that A, R¹, R², R³, and R⁴ may have is preferably a substituted or unsubstituted carbamoyl group having 1 to 30 carbon atoms, e.g., a carbamoyl group, an N-methylcarbamoyl group, an N,N-dimethylcarbamoyl group, an N,N-di-n-octylcarbamoyl group, or an N-(methylsulfonyl)carbamoyl group.

Examples of the aryl- or heterocyclic-azo group that A, R¹, R², R³, and R⁴ may have include a phenylazo group, a 4-methoxyphenylazo group, a 4-pivaloylaminophenylazo group, and a 2-hydroxy-4-propanoylphenylazo group.

Examples of the imido group that A, R¹, R², R³, and R⁴ may have include an N-succinimido group and an N-phthalimido group.

In addition to these substituents, examples of the substituent that A, R¹, R², R³, and R⁴ may have include a hydroxyl group, a cyano group, a nitro group, a sulfo group and a carboxyl group.

These groups may each further have a substituent. Examples of the substituent include the above-mentioned substituents.

A represents a substituted or unsubstituted phenylene group. A is preferably a phenylene group substituted by a methyl group or a chlorine atom, or an unsubstituted phenylene group; and more preferably an unsubstituted phenylene group.

R¹ is preferably a substituted or unsubstituted alkyl group (preferably an alkyl group having 1 to 8 carbon atoms), an allyl group, or a substituted or unsubstituted aryl group (preferably an aryl group having 6 to 10 carbon atoms); more preferably a substituted or unsubstituted alkyl group (preferably an alkyl group having 1 to 6 carbon atoms), or an allyl group; further preferably a substituted or unsubstituted alkyl group (preferably an alkyl group having 1 to 4 carbon atoms); and most preferably an ethyl group.

R² is preferably a substituted or unsubstituted alkyl group (preferably an alkyl group having 1 to 8 carbon atoms), an allyl group, or a substituted or unsubstituted aryl group (preferably an aryl group having 6 to 10 carbon atoms); more preferably a substituted or unsubstituted alkyl group (preferably an alkyl group having 1 to 6 carbon atoms), or an allyl group; further preferably a substituted or unsubstituted alkyl group (preferably an alkyl group having 1 to 4 carbon atoms); and most preferably an ethyl group.

R³ is preferably a substituted or unsubstituted amino group, or a substituted or unsubstituted alkoxy group; more preferably a dialkylamino group (preferably a dialkylamino group having 2 to 8 carbon atoms), an unsubstituted amino group, or an unsubstituted alkoxy group (preferably an alkoxy group having 1 to 6 carbon atoms); further preferably a dialkylamino group (preferably a dialkylamino group having 2 to 4 carbon atoms), or an unsubstituted alkoxy group (preferably an alkoxy group having 1 to 4 carbon atoms); furthermore preferably an unsubstituted alkoxy group (preferably an alkoxy group having 1 to 4 carbon atoms); and most preferably an ethoxy group.

R⁴ is preferably a substituted or unsubstituted alkyl group (preferably an alkyl group having 1 to 8 carbon atoms), or a substituted or unsubstituted aryl group (preferably an aryl group having 6 to 10 carbon atoms); more preferably a substituted or unsubstituted alkyl group (preferably an alkyl group having 1 to 6 carbon atoms), or a substituted or unsubstituted aryl group (preferably an aryl group having 6 to 10 carbon atoms); further preferably a substituted or unsubstituted aryl group (preferably an aryl group having 6 to 10 carbon atoms); furthermore preferably an unsubstituted phenyl group; and most preferably an unsubstituted phenyl group.

The following is an explanation about a preferable combination of various substituents (atoms) that a dye represented by formula (1) may have (combination of A, R¹, R², R³ and R⁴): A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

Examples of a preferred combination of A, R¹, R², R³ and R⁴ in the dye represented by the formula (1) include combinations wherein A is a substituted or unsubstituted phenylene group, R¹ is a substituted or unsubstituted alkyl group having 1 to 8 carbon atoms, an allyl group, or a substituted or unsubstituted aryl group having 6 to 10 carbon atoms, R² is a substituted or unsubstituted alkyl group having 1 to 8 carbon atoms, an allyl group, or a substituted or unsubstituted aryl group having 6 to 10 carbon atoms, R³ is a substituted or unsubstituted amino group, or a substituted or unsubstituted alkoxy group, and R⁴ is a substituted or unsubstituted alkyl group having 1 to 8 carbon atoms, or a substituted or unsubstituted aryl group having 6 to 10 carbon atoms.

In more preferred combinations thereof, A is a substituted or unsubstituted phenylene group, R¹ is a substituted or unsubstituted alkyl group having 1 to 6 carbon atoms, an allyl group, or a substituted or unsubstituted phenyl group, R² is a substituted or unsubstituted alkyl group having 1 to 6 carbon atoms, an allyl group, or a substituted or unsubstituted phenyl group, R³ is a substituted or unsubstituted amino group, or a substituted or unsubstituted alkoxy group, and R⁴ is a substituted or unsubstituted alkyl group having 1 to 6 carbon atoms, or a substituted or unsubstituted phenyl group.

In the most preferred combinations thereof, A is a phenylene group substituted by a methyl group or a chlorine atom, or an unsubstituted phenylene group, R¹ is a substituted or unsubstituted alkyl group having 1 to 4 carbon atoms, or an allyl group, R² is a substituted or unsubstituted alkyl group having 1 to 4 carbon atoms, or an allyl group, R³ is a substituted or unsubstituted amino group, or a substituted or unsubstituted alkoxy group, and R⁴ is a substituted or unsubstituted phenyl group.

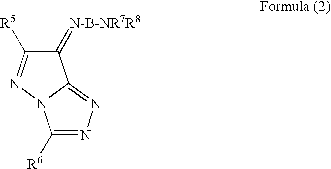

In formula (2), B represents a substituted or unsubstituted phenylene group or a substituted or unsubstituted divalent pyridine ring group; and R⁵, R⁶, R⁷ and R⁸ each independently represent a substituted or unsubstituted alkyl group, a substituted or unsubstituted alkenyl group or a substituted or unsubstituted aryl group.

Each of the groups represented by B, R⁵, R⁶, R⁷ and R⁸ may further have a substituent. Examples of a substituent by which each of the groups of B, R⁵, R⁶, R⁷ and R⁸ may be substituted include the same substituents as each of the substituents A, R¹, R², R³ and R⁴ in the formula (1) may have.

B is preferably a substituted or unsubstituted divalent pyridine ring group or an unsubstituted phenylene group (among these, a substituted or unsubstituted divalent pyridine ring group is preferably); more preferably a divalent pyridine ring group substituted by an alkyl group having 1 to 2 carbon atoms, or an unsubstituted phenylene group; further preferably a divalent pyridine ring group substituted by an alkyl group having 1 to 2 carbon atoms; and most preferably a 6-methyl-pyridine-2,4-diyl group.

R⁵ is preferably a substituted or unsubstituted alkyl group (preferably an alkyl group having 1 to 8 carbon atoms), or a substituted or unsubstituted aryl group (preferably an aryl group having 6 to 10 carbon atoms) (among these, a substituted or unsubstituted alkyl group (preferably an alkyl group having 1 to 8 carbon atoms) are preferable); more preferably a substituted or unsubstituted alkyl group having 1 to 6 carbon atoms or a substituted or unsubstituted phenyl group; further preferably a substituted or unsubstituted alkyl group having 1 to 4 carbon atoms; and most preferably a t-butyl group.

R⁶ is preferably a substituted or unsubstituted alkyl group (preferably an alkyl group having 1 to 8 carbon atoms), or a substituted or unsubstituted aryl group (preferably an aryl group having 6 to 10 carbon atoms) (among these, a substituted or unsubstituted aryl group (preferably an aryl group having 6 to 10 carbon atoms) are preferable); more preferably a substituted or unsubstituted alkyl group having 1 to 6 carbon atoms or a substituted or unsubstituted phenyl group; further preferably a substituted or unsubstituted phenyl group; furthermore preferably an alkyl-substituted phenyl group; and most preferably a 3-methylphenyl group.

R⁷ is preferably a substituted or unsubstituted alkyl group (preferably an alkyl group having 1 to 8 carbon atoms), or a substituted or unsubstituted aryl group (preferably an aryl group having 6 to 10 carbon atoms) (among these, a substituted or unsubstituted alkyl group (preferably an alkyl group having 1 to 8 carbon atoms) are preferable); more preferably a substituted or unsubstituted alkyl group having 1 to 6 carbon atoms, or a substituted or unsubstituted phenyl group; further preferably a substituted or unsubstituted alkyl group having 1 to 4 carbon atoms; and most preferably an ethyl group.

R⁸ is preferably a substituted or unsubstituted alkyl group (preferably an alkyl group having 1 to 8 carbon atoms), or a substituted or unsubstituted aryl group (preferably an aryl group having 6 to 10 carbon atoms) (among these, a substituted or unsubstituted alkyl group (preferably an alkyl group having 1 to 8 carbon atoms) are preferable); more preferably a substituted or unsubstituted alkyl group having 1 to 6 carbon atoms, or a substituted or unsubstituted phenyl group; further preferably a substituted or unsubstituted alkyl group having 1 to 4 carbon atoms; and most preferably an ethyl group.

The following is an explanation about a preferable combination of various substituents (atoms) that a dye represented by formula (2) may have (combination of B, R⁵, R⁶, R⁷ and R⁸): A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

Examples of a preferred combination of B, R⁵, R⁶, R⁷ and R⁸ in the dye represented by the formula (2) include combinations wherein B is a substituted or unsubstituted divalent pyridine ring group or an unsubstituted phenylene group, R⁵ is a substituted or unsubstituted alkyl group having 1 to 8 carbon atoms or a substituted or unsubstituted aryl group having 6 to 10 carbon atoms, R⁶ is a substituted or unsubstituted alkyl group having 1 to 8 carbon atoms or a substituted or unsubstituted aryl group having 6 to 10 carbon atoms, R⁷ is a substituted or unsubstituted alkyl group having 1 to 8 carbon atoms or an allyl group, and R⁸ is a substituted or unsubstituted alkyl group having 1 to 8 carbon atoms or an allyl group.

In more preferred combinations of B, R⁵, R⁶, R⁷ and R⁸, B is a substituted or unsubstituted divalent pyridine ring group or an unsubstituted phenylene group, R⁵ is a substituted or unsubstituted alkyl group having 1 to 6 carbon atoms, R⁶ is a substituted or unsubstituted alkyl group having 1 to 6 carbon atoms, R⁷ is a substituted or unsubstituted alkyl group having 1 to 6 carbon atoms, and R⁸ is a substituted or unsubstituted alkyl group having 1 to 6 carbon atoms.

In the most preferred combinations thereof, B is a substituted or unsubstituted divalent pyridine ring group or an unsubstituted phenylene group, R⁵ is a substituted or unsubstituted alkyl group having 1 to 4 carbon atoms, R⁶ is a substituted or unsubstituted alkyl group having 1 to 4 carbon atoms, R⁷ is a substituted or unsubstituted alkyl group having 1 to 4 carbon atoms, and R⁸ is a substituted or unsubstituted alkyl group having 1 to 4 carbon atoms.

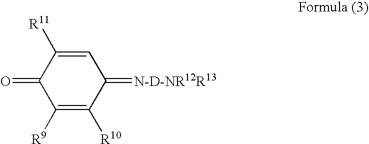

In formula (3), D represents a substituted or unsubstituted phenylene group; R⁹ represents a hydrogen atom or a halogen atom; R¹⁰ represents a substituted or unsubstituted alkyl group; R¹¹ represents a substituted or unsubstituted acylamino group or a substituted or unsubstituted alkoxycarbonylamino group; and R¹² and R¹³ each independently represent a substituted or unsubstituted alkyl group, a substituted or unsubstituted alkenyl group or a substituted or unsubstituted aryl group.

Each of the groups represented by D, R¹⁰, R¹¹, R¹² and R¹³ may further have a substituent. Examples of a substituent by which each of the groups of D, R^{10, R}¹¹, R¹² and R¹³ may be substituted include the same substituents as each of the substituents A, R¹, R², R³ and R⁴ in the formula (1) may have.

D is preferably a phenylene group substituted by an alkyl group having 1 to 4 carbon atoms, a phenylene group substituted by a chlorine atom or an unsubstituted phenylene group; more preferably a phenylene group substituted by an alkyl group having 1 to 2 carbon atoms, or an unsubstituted phenylene group; further preferably a phenylene group substituted by a methyl group, or an unsubstituted phenylene group; and most preferably an unsubstituted phenylene group.

R⁹ is preferably a hydrogen atom, a chlorine atom or a bromine atom, more preferably a hydrogen atom or a chlorine atom, and most preferably a chlorine atom.

R¹⁰ is preferably a substituted or unsubstituted alkyl group having 1 to 8 carbon atoms, more preferably an unsubstituted alkyl group having 1 to 6 carbon atoms, further. preferably an unsubstituted alkyl group (preferably an unsubstituted alkyl group having 1 to 4 carbon atoms), furthermore preferably a methyl group or an ethyl group, and most preferably a methyl group.

R¹¹ is preferably a substituted or unsubstituted acylamino group having 2 to 10 carbon atoms or a substituted or unsubstituted alkoxycarbonylamino group having 2 to 10 carbon atoms, more preferably a substituted or unsubstituted acylamino group having 2 to 8 carbon atoms or a substituted or unsubstituted alkoxycarbonylamino group having 2 to 8 carbon atoms, further preferably a substituted or unsubstituted acylamino group having 2 to 6 carbon atoms or a substituted or unsubstituted alkoxycarbonylamino group having 2 to 6 carbon atoms, furthermore preferably an unsubstituted acylamino group (preferably an unsubstituted acylamino group having 2 to 6 carbon atoms), and most preferably an acetamido group.

R¹² is a substituted or unsubstituted alkyl group (preferably an alkyl group having 1 to 8 carbon atoms), more preferably an unsubstituted alkyl group (an unsubstituted alkyl group having preferably 1 to 8 carbon atoms, more preferably 1 to 6 carbon atoms), further preferably an unsubstituted alkyl group having 1 to 4 carbon atoms, and most preferably an ethyl group.

R¹³ is a substituted or unsubstituted alkyl group (preferably an alkyl group having 1 to 8 carbon atoms), more preferably an unsubstituted alkyl group (an unsubstituted alkyl group having preferably 1 to 8 carbon atoms, more preferably 1 to 6 carbon atoms), further preferably an unsubstituted alkyl group having 1 to 4 carbon atoms, and most preferably an ethyl group.

The following is an explanation about a preferable combination of various substituents (atoms) that a dye represented by formula (3) may have (combination of D, R⁹, R¹⁰, R¹¹, R¹² and R¹³): A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

Examples of a preferred combination of D, R⁹, R¹⁰, R¹¹, R¹² and R¹³ in the dye represented by the formula (3) include combinations wherein D is a phenylene group substituted by an alkyl group having 1 to 4 carbon atoms, a phenylene group substituted by a chlorine atom or an unsubstituted phenylene group, R⁹ is a hydrogen atom, a chlorine atom or a bromine atom, R¹⁰ is a substituted or unsubstituted alkyl group having 1 to 8 carbon atoms, R¹¹ is a substituted or unsubstituted acylamino group having 2 to 10 carbon atoms or a substituted or unsubstituted alkoxycarbonylamino group having 2 to 10 carbon atoms, R¹² is a substituted or unsubstituted alkyl group having 1 to 8 carbon atoms, and R¹³ is a substituted or unsubstituted alkyl group having 1 to 8 carbon atoms.

In preferred combinations of D, R⁹, R¹⁰, R¹¹, R¹² and R¹³, D is a phenylene group substituted by an alkyl group having 1 to 2 carbon atoms or an unsubstituted phenylene group, R⁹ is a hydrogen atom or a chlorine atom, R¹⁰ is a substituted or unsubstituted alkyl group having 1 to 6 carbon atoms, R¹¹ is a substituted or unsubstituted acylamino group having 2 to 8 carbon atoms or a substituted or unsubstituted alkoxycarbonylamino group having 2 to 8 carbon atoms, R¹² is a substituted or unsubstituted alkyl group having 1 to 6 carbon atoms, and R¹³ is a substituted or unsubstituted alkyl group having 1 to 6 carbon atoms.

In the most preferred combinations of D, R⁹, R¹⁰, R¹¹, R¹² and R¹³, D is a phenylene group substituted by a methyl group or an unsubstituted phenylene group, R⁹ is a hydrogen atom or a chlorine atom, R¹⁰ is a substituted or unsubstituted alkyl group having 1 to 6 carbon atoms, R¹¹ is a substituted or unsubstituted acylamino group having 2 to 6 carbon atoms or a substituted or unsubstituted alkoxycarbonylamino group having 2 to 6 carbon atoms, R¹² is a substituted or unsubstituted alkyl group having 1 to 4 carbon atoms, and R¹³ is a substituted or unsubstituted alkyl group having 1 to 4 carbon atoms.

Specific examples of compounds as the dyes represented by any one of the formulae (1) to (3) are illustrated below. However, the dyes represented by the formulae (1) to (3) should not be restrictedly interpreted by the specific examples illustrated below.

TABLE 1
Dyes represented by formula (1)

| Examples of | | | | | |
|---|---|---|---|---|---|
| compounds | A | R¹ | R² | R³ | R⁴ |
| 1-1 | 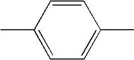 | Ethyl | Ethyl | Ethoxy | Phenyl |
| 1-2 | 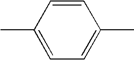 | Ethyl | Ethyl | Dimethylamino | Phenyl |
| 1-3 | 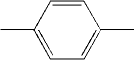 | n-Propyl | n-Propyl | Ethoxy | Phenyl |
| 1-4 | 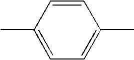 | n-Butyl | n-Butyl | Ethoxy | Phenyl |

TABLE 2
Dyes represented by formula (2)

| Examples of | | | | | |
|---|---|---|---|---|---|
| compounds | B | R⁵ | R⁶ | R⁷ | R⁸ |
| 2-1 | 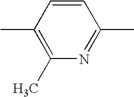 | t-Butyl | 3-Methylphenyl | Ethyl | Ethyl |
| 2-2 | 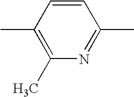 | t-Butyl | 3-Methylphenyl | n-Propyl | n-Propyl |
| 2-3 | 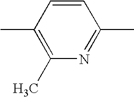 | Methyl | Phenyl | Ethyl | Methoxyethyl |
| 2-4 | 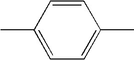 | 2-Chlorophenyl | Isopropyl | n-Butyl | Cyanoethyl |

TABLE 3
Dyes represented by formula (3)

| Examples of | | | | | | |
|---|---|---|---|---|---|---|
| compounds | D | R⁹ | R¹⁰ | R¹¹ | R¹² | R¹³ |
| 3-1 | 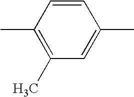 | Chloro | Methyl | Acetylamino | Ethyl | Ethyl |
| 3-2 | 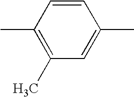 | Hydrogen | Methyl | Acetylamino | Ethyl | Ethyl |
| 3-3 | 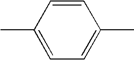 | Chloro | Methyl | 3-Pyridine carbonylamino | n-Propyl | n-Propyl |
| 3-4 | 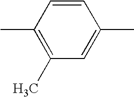 | Chloro | Methyl | Benzoylamino | Ethyl | Ethyl |
| 3-5 | 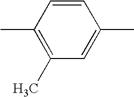 | Chloro | Methyl | Ethoxycarbonylamino | Ethyl | Ethyl |
| 3-6 | 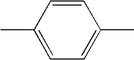 | Chloro | Ethyl | 2-Furoylamino | Ethyl | Ethyl |

Among the dyes represented by formula (1), commercially unavailable ones can be synthesized by a general dehydration-condensation reaction between a pyrazolone derivative and an aminobenzaldehyde derivative.

Among the dyes represented by formula (2), commercially unavailable ones can be typically synthesized by the method described in JP-A-7-137455 or methods based thereon.

Among the dyes represented by formula (3), commercially unavailable ones can be typically synthesized by the method described in JP-A-61-31292 or methods based thereon.

### (Other Dyes)

Colorants can be used together with the dyes for use in the present invention. Such colorants are not particularly limited, so far as the colorants are able to diffuse by heat and able to be incorporated in a heat-sensitive transfer sheet, and able to transfer by heat from the heat-sensitive transfer sheet to an image-receiving sheet. The dyes that have been conventionally used for the heat-sensitive transfer sheet or known dyes can be effectively used.

Preferable examples of the dyes to be used together include diarylmethane-series dyes, triarylmethane-series dyes, thiazole-series dyes, methine-series dyes such as merocyanine; azomethine-series dyes typically exemplified by indoaniline, acetophenoneazomethine, pyrazoloazomethine, imidazole azomethine, imidazo azomethine, and pyridone azomethine; xanthene-series dyes; oxazine-series dyes; cyanomethylene-series dyes typically exemplified by dicyanostyrene, and tricyanostyrene; thiazine-series dyes; azine-series dyes; acridine-series dyes; benzene azo-series dyes; azo-series dyes such as pyridone azo, thiophene azo, isothiazole azo, pyrol azo, pyralazo, imidazole azo, thiadiazole azo, triazole azo, and disazo; spiropyran-series dyes; indolinospiropyran-series dyes; fluoran-series dyes; rhodaminelactam-series dyes; naphthoquinone-series dyes; anthraquinone-series dyes; and quinophthalon-series dyes.

Specific examples of the yellow dyes include Disperse Yellow 231, Disperse Yellow 201 and Solvent Yellow 93. Of these, Solvent Yellow 93 is particularly preferable. Specific examples of the magenta dyes include Disperse Violet 26, Disperse Red 60, and Solvent Red 19. Of these, Disperse Violet 26 and Disperse Red 60 are particularly preferable. Specific examples of the cyan dyes include Solvent Blue 63, Solvent Blue 36, Disperse Blue 354 and Disperse Blue 35. Of these, Solvent Blue 63 is particularly preferable. As a matter of course, it is also possible to use suitable dyes other than these dyes as exemplified above.

Further, dyes each having a different hue from each other as described above may be arbitrarily combined together. For instance, a black hue can be obtained from a combination of dyes.

### (Binder)

It is preferable that the dyes for use in the present invention are used in combination with a binder. As the binder, various kinds of binder are known, and these can be used in the present invention. Examples thereof include acrylic resins such as polyacrylonitrile, polyacrylate, and polyacrylamide; polyvinyl acetal resins such as polyvinyl acetoacetal, and polyvinyl butyral; cellulose series resins and modified cellulose series resins such as ethylcellulose, hydroxyethylcellulose, ethylhydroxycellulose, hydroxypropylcellulose, ethylhydroxyethylcellulose, methylcellulose, cellulose acetate, cellulose acetate butyrate, cellulose acetate propionate, cellulose nitrate; other resins such as polyurethane resin, polyamide resin, polyester resin, polycarbonate resin, phenoxy resin, phenol resin, and epoxy resin; and various elastomers. The dye layer may be made of at least one resin selected from the above-mentioned group.

These may be used alone, or two or more thereof may be used in the form of a mixture or copolymer. These may be crosslinked with various crosslinking agents.

The binder in the invention is preferably a cellulose resin or a polyvinyl acetal resin, more preferably a polyvinyl acetal resin. In particular, polyvinyl acetoacetal resin, polyvinyl butyral resin or a copolymer of polyvinyl acetoacetal and polyvinyl butyral resin is preferably used in the prevent invention.

The molar ratio Ac/Bt of acetoacetal (Ac) to butyral (Bt) in the copolymer or the mixture of the resins is preferably in the range of 5 to 90, particularly preferably in the range of 15 to 45. The molar ratio of the acetoacetal to the butyral can be easily obtained from the integration value of ¹H-NMR.

### (Dye Barrier Layer)

In the heat-sensitive transfer sheet of the present invention, a dye barrier layer may be formed between the dye layer and the support.

### (Treatment for Easy Adhesion)

The surface of the support may be subjected to treatment for easy adhesion to improve wettability and an adhesive property of the coating liquid. Examples of the treatment include corona discharge treatment, flame treatment, ozone treatment, ultraviolet treatment, radial ray treatment, surface-roughening treatment, chemical agent treatment, vacuum plasma treatment, atmospheric plasma treatment, primer treatment, grafting treatment, and other known resin surface modifying treatments.

An easily-adhesive layer may be formed on the support by coating. Examples of the resin used in the easily-adhesive layer include polyester-series resins, polyacrylate-series resins, polyvinyl acetate-series resins, vinyl-series resins such as polyvinyl chloride resin and polyvinyl alcohol resin, polyvinyl acetal-series resins such as polyvinyl acetoacetal and polyvinyl butyral, polyether-series resins, polyurethane-series resins, styrene acrylate-series resins, polyacrylamide-series resins, polyamide-series resins, polystyrene-series resins, polyethylene-series resins, and polypropylene-series resins.

When a film used for the support is formed by melt extrusion, it is allowable to subject a non-drawn film to coating treatment followed by drawing treatment.

The above-mentioned treatments may be used in combination of two or more thereof.

### (Transferable Protective Layer)

In the present invention, the heat-sensitive transfer sheet preferably has a transferable protective layer, which is preferably incorporated as a transferable protective layer laminate.

### (Transferable Protective Layer Laminate)

In the invention, a transferable protective layer laminate is preferably formed in area order onto the heat-sensitive transfer sheet. The transferable protective layer laminate is used to protect a heat-transferred image with a protective layer composed of a transparent resin, thereby to improve durability such as scratch resistance, light-fastness, and resistance to weather. This laminate is effective in the case where the transferred dye is insufficient in image durability such as light resistance, scratch resistance, and chemical resistance in the state that the dye is naked in the surface of an image-receiving sheet.

The transferable protective layer laminate can be formed by forming, onto a support, a releasing layer, a protective layer and an adhesive layer in this order successively. The protective layer may be formed by plural layers. In the case where the protective layer also has functions of other layers, the releasing layer and the adhesive layer can be omitted. It is also possible to use a support on which an easy adhesive layer has already been formed.

### (Transferable Protective Layer)

In the present invention, as a transferable protective layer-forming resin, preferred are resins that are excellent in scratch resistance, chemical resistance, transparency and hardness. Examples of the resin include polyester resins, acrylic resins, polystyrene resins, polyurethane resins, acrylic urethane resins, silicone-modified resins of the above-described resins, ultraviolet-shielding resins, mixtures of these resins, ionizing radiation-curable resins, and ultraviolet-curing resins. Particularly preferred are polyester resins and acrylic resins.

These resins may be crosslinked with various crosslinking agents.

### (Transferable Protective Layer Resin)

As the acrylic resin, use can be made of polymers derived from at least one monomer selected from conventionally known acrylate monomers and methacrylate monomers. Other monomers than these acrylate-series monomers, such as styrene and acrylonitrile may be co-polymerized with said acrylic monomers. A preferred monomer is methyl methacrylate. It is preferred that methyl methacrylate is contained in terms of preparation mass ratio of 50 mass % or more in the polymer.

The acrylic resin in the invention preferably has a molecular weight of 20,000 or more and 100,000 or less. If the molecular weight is too small, oligomers are produced during synthesis. They make it difficult to maintain stability of properties. On the other hand, if the molecular weight is too large, a foil-off property deteriorates at the time when the protective layer is transferred.

The polyester resin in the invention may be a saturated polyester resin known in the prior art. As the above-described polyester resin, a preferable glass transition temperature ranges from 50° C. to 120° C., and a preferable molecular weight ranges from 2,000 to 40,000. A molecular weight ranging from 4,000 to 20,000 is more preferred, because so-called “foil-off” properties at the time of transfer of the protective layer are improved.

### (Ultraviolet Absorbent)

In the protective layer transferring sheet in the invention, an ultraviolet absorbent may be incorporated into the protective layer and/or the adhesive layer. The ultraviolet absorbent may be an inorganic ultraviolet absorbent or organic ultraviolet absorbent known in the prior art.

As the organic ultraviolet absorbents, use can be made of non-reactive ultraviolet absorbents such as salicylate-series, benzophenone-series, benzotriazole-series, triazine-series, substituted acrylonitrile-series, and hindered amine-series ultraviolet absorbents; and copolymers or graft polymers of thermoplastic resins (e.g., acrylic resins) obtained by introducing addition-polymerizable double bonds (originated from a vinyl group, an acryroyl group, a methacryroyl group, or the like) to the above-described non-reactive ultraviolet absorbents, or alternatively by introducing thereto other types of groups such as an alcoholic hydroxyl group, an amino group, a carboxyl group, an epoxy group, and an isocyanate group. In addition, disclosed is a method of obtaining ultraviolet-shielding resins by the steps of dissolving ultraviolet absorbents in a monomer or oligomer of the resin to be used in the protective layer, and then polymerizing the monomer or oligomer (JP-A-2006-21333). In this case, the ultraviolet absorbents may be non-reactive.

Of these ultraviolet absorbents, preferred are benzophenone-series, benzotriazole-series, and triazine-series ultraviolet absorbents. It is preferred that these ultraviolet absorbents are used in combination so as to cover an effective ultraviolet absorption wavelength region according to characteristic properties of the dye that is used for image formation. Besides, in the case of non-reactive ultraviolet absorbents, it is preferred to use a mixture of two or more kinds of ultraviolet absorbents each having a different structure from each other so as to prevent the ultraviolet absorbents from precipitation.

Examples of commercially available ultraviolet absorbents include TINUVIN-P (trade name, manufactured by Ciba-Geigy), JF-77 (trade name, manufactured by JOHOKU CHEMICAL CO., LTD.), SEESORB 701 (trade name, manufactured by SHIRAISHI CALCIUM KAISHA, LTD.), SUMISORB 200 (trade name, manufactured by Sumitomo Chemical Co., Ltd.), VIOSORB 520 (trade name, manufactured by KYODO CHEMICAL CO., LTD.), and ADKSTAB LA-32 (trade name, manufactured by ADEKA).

### (Curable Resins)

The use of ionizing radiation-curable resins or ultraviolet curable resins enables to obtain a protective layer that excels in both resistance to plasticizers and scratch resistance in particular. As an example, there are resins that are obtained by cross-linking and curing radical polymerizable polymers or oligomers upon irradiation of ionizing radiation. At this moment, polymerization and cross-linking may be performed by adding a photopolymerization initiator in accordance with necessity, followed by irradiation of electron beam or ultraviolet ray. Further, known ionizing radiation-curable resins can be used.

### (Filler)

In the present invention, organic fillers and/or inorganic fillers can be preferably used. Examples of the organic fillers and/or the inorganic fillers include polyethylene wax, bis-amide, nylon, acrylic resin, cross-linked polystyrene, silicone resin, silicone rubber, talc, calcium carbonate, titanium oxide, alumina, and silica fine-particles such as micro silica and colloidal silica. In the heat-sensitive transfer sheet of the present invention, not only these exemplified materials, but also known other materials can be used suitably.

With respect to the organic fillers and/or the inorganic fillers, it is preferred that a particle diameter of the fillers is 10 μm or less, preferably in the range of 0.1 μm to 3 μm, and the fillers have good sliding properties and high transparency. An addition amount of the filler is preferably not much more than a degree to which transparency is kept at the time of transfer. Specifically, the addition amount is preferably in the range of 0 to 100 mass parts, based on 100 mass parts of the resin.

### (Formation of the Transferable Protective Layer)

The method for forming the protective layer, which depends on the kind of the resin to be used, may be the same method for forming the dye layer. The protective layer preferably has a thickness of 0.5 to 10 μm.

### (Releasing Layer)

In a case where the protective layer is not easily peeled from the support in the protective layer transferring sheet when the image is thermally transferred, a releasing layer may be formed between the support and the protective layer. A peeling layer may be formed between the transferable protective layer and the releasing layer. The releasing layer may be formed by painting a coating liquid by a method known in the prior art, such as gravure coating or gravure reverse coating, and then drying the painted liquid. The coating liquid contains at least one selected from, for example, waxes, silicone waxes, silicone resins, fluorine-contained resins, acrylic resins, polyvinyl alcohol resins, cellulose derivative resins, urethane-series resins, vinyl acetate-series resins, acrylic vinyl ether-series resins, maleic anhydride resins, and copolymers of these resins. Of these resins, preferred are: acrylic resins, such as resin obtained by homopolymerizing a (meth)acrylic monomer such as acrylic acid or methacrylic acid, or obtained by copolymerizing a methacrylic monomer with a different monomer; or cellulose derivative resins. They are each excellent in adhesive property to the support, and releasing ability from the protective layer.

These resins may be crosslinked with various crosslinking agents. Moreover, ionizing radiation curable resin and ultraviolet curable resin may be used.

The releasing layer may be appropriately selected from a releasing layer which is transferred to a transferred-image-receiving member when the image is thermally transferred, a releasing layer which remains on the support side at that time, a releasing layer which is broken out by aggregation at that time, and other releasing layers. A preferred embodiment of the invention is an embodiment wherein the releasing layer remains on the support side at the time of the thermal transfer and the interface between the releasing layer and the thermally transferable protective layer becomes a protective layer surface after the thermal transfer since the embodiment is excellent in surface gloss, the transfer stability of the protective layer, and others. The method for forming the releasing layer may be a painting method known in the prior art. The releasing layer preferably has a thickness of about 0.5 to 5 μm in the state that the layer is dried.

### (Adhesive Layer)

An adhesive layer may be formed, as the topmost layer of the transferable protective layer laminate, on the topmost surface of the protective layer. This makes it possible to make the adhesive property of the protective layer to a transferred-image-receiving member good.

### (Back Side Layer)

In the heat-sensitive transfer sheet that is used in the present invention, it is preferred to dispose a back side layer on the surface (back side) of the support opposite to the dye layer coating side of the support, namely on the same side as the surface with which a thermal head etc. contacts. Further, in the case of a protective layer transfer sheet, it is also preferred to dispose a back side layer on the surface (back side) of the support opposite to the transferable protective layer coating side of the support, namely on the same side as the surface with which a thermal head etc. contacts.

If the heat-sensitive transfer sheet is heated by a heating device such as a thermal head in the state such that the back side of the support of the transfer sheet directly contacts with the heating device, heat seal is apt to occur. In addition, owing to a large friction between them, it is difficult to smoothly transfer the heat-sensitive transfer sheet at the time of copying.

The back side layer is disposed so that the heat-sensitive transfer sheet enables to withstand heat energy from a thermal head. The back side layer prevents the heat seal, and enables a smooth travel action. Recently, the necessity of the back side layer is becoming greater on account that the heat energy from a thermal head is increasing in association with speeding-up of the printer.

The back side layer is formed by coating a composition wherein additives such as a sliding agent, a release agent, a surfactant, inorganic particles, organic particles, and pigments are added to a binder. Further, an interlayer may be disposed between the back side layer and the support. As the interlayer, there has been known a layer containing inorganic fine particles and a water-soluble resin or a hydrophilic resin capable of emulsification.

As the binder, there can be used known resins with high heat resistance. Examples of the binder include a single substance or a mixture of cellulose series resins such as ethyl cellulose, hydroxycellulose, hydroxypropylcellulose, methyl cellulose, cellulose acetate, cellulose acetate butyrate, cellulose acetate propionate, and nitrocellulose; polyvinyl series resins such as polyvinyl alcohol, polyvinyl acetate, polyvinyl butyral, polyvinyl acetal, polyvinyl acetoacetal resin, vinyl chloride-vinyl acetate copolymer, and polyvinyl pyrrolidone; acrylic resins such as polymethyl methacrylate, polyethyl acrylate, polyacrylamide, and acrylonitrile-styrene copolymer; polyamide resins, polyimide resins, polyamidoimide resins, polyvinyl toluene resins, cumarone indene resins, polyester-series resins, polyurethane resins, polyether resins, polybutadiene resins, polycarbonate resins, chlorinated polyolefin resins, fluorine resins, epoxy resins, phenolic resins, silicone resins, and natural or synthetic resins of silicone-modified or fluorine-modified urethane.

In the present invention, acrylic resins are preferable, and acrylic polyol resins are more preferable among these binders. The “acrylic polyol” here means acrylic resins having plurality of OH groups which can react with hardeners such as isocyanate groups. Examples of the acrylic polyol include ACRYDIC A-801, ACRYDIC A-817, ACRYDIC A-823, ACRYDIC A-837, ACRYDIC A-848-RN, and ACRYDIC A-814 (all trade names, manufactured by Dainippon Ink and Chemicals, Incorporated). Hereby, the effects according to the present invention can be exhibited efficiently.

In order to enhance heat resistance of the back side layer, there have been known techniques of cross-linked resins by ultraviolet ray or electron beam radiation. Further, the resin may be cross-linked by heating with a cross-linking agent. This cross-linked resin is particularly preferably used in the present invention. According to need, catalyst may be added to the resin. As an exemplary cross-linking agent, poly isocyanate is known. When the poly isocyanate is used, a resin with a hydroxyl group-based functional group is suited to be cross-linked. This resin is also preferably used in the present invention. JP-A-62-259889 discloses that a back side layer is formed of a reaction product of polyvinyl butyral and an isocyanate compound, to which a bulking agent such as an alkali metal salt or alkaline earth metal salt of phosphoric ester and potassium carbonate is added. JP-A-6-99671 discloses that a heat resistant lubricating layer-forming high molecular compound can be obtained by reacting a silicone compound having an amino group and an isocyanate compound having two or more isocyanate groups in the molecule.

Functions of the back side layer may be fully attained by adding thereto additives such as a sliding agent, a plasticizer, a stabilizer, a bulking agent, and filler for eliminating materials adhered on a head.

Examples of the sliding agent include fluorides such as calcium fluoride, barium fluoride and graphite fluoride; sulfides such as molybdenum disulfide, tungsten disulfide and iron sulfide; oxides such as lead oxide, alumina, and molybdenum oxide; solid sliding agents of inorganic compounds such as graphite, mica, boron nitride, and clays (e.g., talc, acid clay); organic resins such as fluorine resins and silicone resins; silicone oil; metal soaps such as metal salt of stearic acid; various kinds of waxes such as polyethylene wax and paraffin wax; and surfactants such as anionic surfactants, cationic surfactants, amphoteric surfactants, nonionic surfactants, and fluorine surfactants.

It is also possible to use phosphoric ester surfactants such as zinc salt of alkyl phosphoric monoester or alkyl phosphoric diester. However, the acid group of the phosphate causes a disadvantage such that the phosphate decomposes as a heat quantity from a thermal head becomes large, and consequently the pH of the back side layer lowers, corrosive abrasion of the thermal head becomes heavier. As a measure to deal with the disadvantage, there are known, for example, a method of using a neutralized phosphate surfactant, and a method of using a neutralizing agent such as magnesium hydroxide.

Examples of the other additives include higher fatty acid alcohol esters, organopolysiloxane, organic carboxylic acids and derivatives thereof, and fine particles of inorganic compounds such as talc and silica.

In the present invention, it is preferable to contain both of a metal salt of stearic acid (in particular zinc stearate) and a phosphoric ester (in particular a metal salt such as a zinc salt of an alkyl phosphoric monoester or an alkyl phosphoric diester) in the back side layer.

The back side layer is formed by adding the essential components and optional additives to the binder, examples of which have been described above, dissolving or dispersing the resultant into a solvent to prepare a coating liquid, and then painting the coating liquid by a known method such as gravure coating, roll coating, blade coating or wire bar coating. The film thickness of the back side layer is preferably from 0.1 to 10 μm, more preferably from 0.5 to 5 μm.

### (Support)

There is no particular limitation to the support for use of both the heat-sensitive transfer sheet and the protective layer transfer sheet that are used in the present invention. It is possible to use any one of supports known from the past, so long as they have sufficient heat resistance and mechanical strength.

As the support, polyamides and polyimides and polyesters are exemplified.

A thickness of the support can be properly determined in accordance with the material of the support so that the mechanical strength and the heat resistance become optimum. Specifically, it is preferred to use a support having a thickness of about 1 μm to about 100 μm, more preferably from about 2 μm to 50 μm, and further preferably from about 3 μm to about 10 μm.

### (Heat-Sensitive Transfer Image-Receiving Sheet)

The heat-sensitive transfer image-receiving sheet for use in the present invention is explained in detail below.

The heat-sensitive transfer image-receiving sheet of the present invention (hereinafter also referred to as the image-receiving sheet of the present invention) preferably has at least one receptor layer (dye receptor layer) on a support, and at least one heat insulation layer (porous layer) between the support and the receptor layer. Further, between the support and the receptor layer, there may be formed an interlayer having various functions such as white back ground controlling, antistatic, adhesion, and leveling functions. Further, a release layer may be formed at the outermost layer on the side of which a heat-sensitive transfer sheet is superposed. In addition, it is one of preferable embodiments that the heat-sensitive transfer sheet has two receptor layers in the present invention.

In the present invention, it is preferred that at least one of the receptor layer, the heat insulation layer and the interlayer be coated with the use of an aqueous type coating liquid. Coating of each layer may be performed by an ordinary method such as roll coat, bar coat, gravure coat, gravure reverse coat, die coat, slide coat, and curtain coat. Each of the receptor layer, the heat insulation layer and the interlayer may be coated individually, or an arbitrary combination of these layers may be simultaneously multilayer coated. It is particularly preferable that the receptor layer and the heat insulation are multilayer-coated simultaneously on a support. On the side of the support opposite to the receptor layer coating side, a curl adjusting layer, a recording layer or a static adjusting layer may be disposed.

### (Receptor Layer)

The heat-sensitive transfer image-receiving sheet of the present invention has at least one receptor layer having a thermoplastic receptive polymer capable of receiving at least a dye.

Examples of preferable receptive polymers include vinyl-based resins such as polyvinyl acetate, ethylene vinyl acetate copolymer, vinyl chloride vinyl acetate copolymer, vinyl chloride acrylic copolymer, vinyl chloride methacrylic copolymer, polyacrylic ester, polystyrene, and acrylic polystyrene; acetal resins such as polyvinyl formal, polyvinyl butyral, and polyvinyl acetal; polyester resins such as polyethyleneterephthalate, polybutyleneterephthalate and polycaprolactone; polycarbonate-based resins; polyurethane-based resins; cellulose-based resins; polyolefin-based resins such as polypropylene; polyamide-based resin; and amino resins such as urea resins, melamine resins and benzoguanamine resins. These resins may be used optionally blending with each other in the range of compatibility.

It is further preferable, among these polymers, to use a polycarbonate, a polyester, a polyurethane, a polyvinyl chloride or a copolymer of vinyl chloride, a styrene-acrylonitrile copolymer, a polycaprolactone or a mixture of two or more of these. It is particularly preferable to use a polyester, a polyvinyl chloride or a copolymer of vinyl chloride, or a mixture of these.

The above-exemplified polymers may be added to a water-based coating liquid as latex polymer so that they can be coated on a support.

Further, the receptor layer may contain ultraviolet absorbents, release agents, sliding agents, antioxidants, antiseptics, and surfactants.

### <Latex Polymer>

It is preferred to contain latex polymer in a receptor layer that is coated in the heat-sensitive transfer image-receiving sheet of the present invention.

The latex polymer for use in the receptor layer is a dispersion in which water-insoluble hydrophobic polymers are dispersed as fine particles in a water-soluble dispersion medium. The dispersed state may be one in which polymer is emulsified in a dispersion medium, one in which polymer underwent emulsion polymerization, one in which polymer underwent micelle dispersion, one in which polymer molecules partially have a hydrophilic structure and thus the molecular chains themselves are dispersed in a molecular state, or the like. The dispersed particles preferably have a mean average particle size (diameter) of about 1 to 50,000 nm, more preferably about 5 to 1,000 nm.

The glass transition temperature (Tg) of the latex polymer that can be used in the present invention is preferably −30° C. to 100° C., more preferably 0° C. to 80° C., further preferably 10° C. to 70° C., and further more preferably 15° C. to 60° C.

In a preferable embodiment of the latex polymer used in the heat-sensitive transfer image-receiving sheet according to the present invention, latex polymers such as acrylic-series polymers, polyesters, rubbers (e.g., SBR resins), polyurethanes, polyvinyl chloride copolymers including copolymers such as vinyl chloride/vinyl acetate copolymer, vinyl chloride/acrylic copolymer, and vinyl chloride/methacrylic copolymer; polyvinyl acetate copolymers including copolymers such as ethylene/vinyl acetate copolymer; and polyolefins, are preferably used. These latex polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number-average molecular weight.

The latex polymer according to the present invention is preferably exemplified by any one of polyester latexes; vinyl chloride latex copolymers such as vinyl chloride/acrylic compound latex copolymer, vinyl chloride/vinyl acetate latex copolymer, and vinyl chloride/vinyl acetate/acrylic compound latex copolymer, or arbitrary combinations thereof.

Examples of the vinyl chloride copolymer include those described above. Among these, VINYBLAN 240, VINYBLAN 270, VINYBLAN 276, VINYBLAN 277, VINYBLAN 375, VINYBLAN 380, VINYBLAN 386, VINYBLAN 410, VINYBLAN 430, VINYBLAN 432, VINYBLAN 550, VINYBLAN 601, VINYBLAN 602, VINYBLAN 609, VINYBLAN 619, VINYBLAN 680, VINYBLAN 680S, VINYBLAN 681N, VINYBLAN 683, VINYBLAN 685R, VINYBLAN 690, VINYBLAN 860, VINYBLAN 863, VINYBLAN 865, VINYBLAN 867, VINYBLAN 900, VINYBLAN 938 and VINYBLAN 950 (trade names, manufactured by Nissin Chemical Industry Co., Ltd.); and SE1320, S-830 (trade names, manufactured by Sumica Chemtex) are preferable.

### (Polyester-Series Latexes)

The polyester-series latex is preferably exemplified by VIRONAL MD1200, VIRONAL MD1220, VIRONAL MD1245, VIRONAL MD1250, VIRONAL MD1500, VIRONAL MD1930, and VIRONAL MD1985 (trade names, manufactured by Toyobo Co., Ltd.).

Among these, vinyl chloride-series latex copolymers such as a vinyl chloride/acrylic compound latex copolymer, a vinyl chloride/vinyl acetate latex copolymer, a vinyl chloride/vinyl acetate/acrylic compound latex copolymer, are more preferable.

Further, in the present invention, it is preferable to have at least two kinds of latex polymers in the receptor layer, and each of these latex polymers is more preferably a polyvinylchloride series latex polymers. Furthermore, in the present invention, it is also one of preferable embodiments that the receptor layer is made of two or more layers, and each of the two or more layers contains a polyvinylchloride series latex polymer. It is most preferable in the case where at least one of the two or more layers has at least one kind of polyvinylchloride series latex polymer which is different kind of the polyvinylchloride series latex polymer of the other layer.

### <Water-Soluble Polymer>

In the heat-sensitive transfer image-receiving sheet of the present invention, it is one of preferred embodiments of the present invention that the receptor layer contains a water-soluble polymer.

Herein, the “water-soluble polymer” means a polymer which dissolves, in 100 g of water at 20° C., in an amount of preferably 0.05 g or more, more preferably 0.1 g or more, further preferably 0.5 g or more, and particularly preferably 1 g or more. As the water-soluble polymers, natural polymers, semi-synthetic polymers and synthetic polymers are preferably used.

Among the water-soluble polymer that can be used in the heat-sensitive transfer image-receiving sheet of the present invention, the natural polymers and the semi-synthetic polymers will be explained in detail. Specific examples include the following polymers: plant type polysaccharides such as κ-carrageenans, ι-carrageenans, λ-carrageenans, and pectins; microbial type polysaccharides such as xanthan gums and dextrins; animal type natural polymers such as gelatins and caseins; and cellulose-based polymers such as carboxymethylcelluloses, hydroxyethylcelluloses, and hydroxypropylcelluloses.

Of the natural polymers and the semi-synthetic polymers that can be used in the present invention, gelatin is preferred. Gelatin having a molecular mass of 10,000 to 1,000,000 may be used in the present invention. Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

Of the water-soluble polymers that can be used in the heat-sensitive transfer image-receiving sheet of the present invention, examples of the synthetic polymers include polyvinyl pyrrolidone, polyvinyl pyrrolidone copolymers, polyvinyl alcohol, polyethylene glycol, polypropylene glycol, and water-soluble polyesters.

Among the synthetic polymers that can be used in the present invention, polyvinyl alcohols are preferable.

As the polyvinyl alcohol, there can be used various kinds of polyvinyl alcohols such as complete saponification products thereof, partial saponification products thereof, and modified polyvinyl alcohols. With respect to these polyvinyl alcohols, those described in Koichi Nagano, et al., “Poval”, Kobunshi Kankokai, Inc. are useful.

The viscosity of polyvinyl alcohol can be adjusted or stabilized by adding a trace amount of a solvent or an inorganic salt to an aqueous solution of polyvinyl alcohol, and use may be made of compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid to be added is preferably 0.01 to 40 mass %, with respect to polyvinyl alcohol.

Specific examples of the polyvinyl alcohols include completely saponificated polyvinyl alcohol such as PVA-105, PVA-110, PVA-117 and PVA-117H (trade names, manufactured by KURARAY CO., LTD.); partially saponificated polyvinyl alcohol such as PVA-203, PVA-205, PVA-210 and PVA-220 (trade names, manufactured by KURARAY CO., LTD.); and modified polyvinyl alcohols such as C-118, HL-12E, KL-118 and MP-203 (trade names, manufactured by KURARAY CO., LTD.).

A preferable addition amount of the latex polymer is in the range of 50% by mass to 98% by mass, more preferably from 70% by mass to 95% by mass, in terms of solid content of the latex polymer in the receptor layer.

In the heat-sensitive transfer image-receiving sheet of the present invention, at least one receptor layer may be coated with an aqueous type coating liquid. In the case where the image-receiving sheet has a plurality of receptor layers, it is preferred to coat all of these layers with an aqueous type coating liquid, followed by drying for production. The “aqueous type” here means that 60% by mass or more of the solvent (dispersion medium) of the coating liquid is water. As a component other than water in the coating liquid, a water miscible organic solvent may be used. Examples thereof include methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether.

### (Ultraviolet Absorbent)

The heat-sensitive transfer image-receiving sheet of the present invention may contain any ultraviolet absorbents. As the ultraviolet absorbents, use can be made of conventionally known inorganic or organic ultraviolet absorbents. As the organic ultraviolet absorbents, use can be made of non-reactive ultraviolet absorbents such as salicylate-series, benzophenone-series, benzotriazole-series, triazine-series, substituted acrylonitrile-series, and hindered amine-series ultraviolet absorbents; copolymers or graft polymers of thermoplastic resins (e.g., acrylic resins) obtained by introducing an addition-polymerizable double bond (e.g., a vinyl group, an acryroyl group, a methacryroyl group), or an alcoholic hydroxyl group, an amino group, a carboxyl group, an epoxy group, or an isocyanate group, to the non-reactive ultraviolet absorbents, subsequently copolymerizing or grafting. In addition, disclosed is a method of obtaining ultraviolet-shielding resins by the steps of dissolving ultraviolet absorbents in a monomer or oligomer of the resin to be used, and then polymerizing the monomer or oligomer (JP-A-2006-21333). In this case, the ultraviolet absorbents may be non-reactive.

Of these ultraviolet absorbents, preferred are benzophenone-series, benzotriazole-series, and triazine-series ultraviolet absorbents. It is preferred that these ultraviolet absorbents are used in combination so as to cover an effective ultraviolet absorption wavelength region according to characteristic properties of the dye that is used for image formation. Besides, in the case of non-reactive ultraviolet absorbents, it is preferred to use a mixture of two or more kinds of ultraviolet absorbents each having a different structure from each other so as to prevent the ultraviolet absorbents from precipitation.

Examples of commercially available ultraviolet absorbents include TINUVIN-P (trade name, manufactured by Ciba-Geigy), JF-77 (trade name, manufactured by JOHOKU CHEMICAL CO., LTD.), SEESORB 701 (trade name, manufactured by SHIRAISHI CALCIUM KAISHA, LTD.), SUMISORB 200 (trade name, manufactured by Sumitomo Chemical Co., Ltd.), VIOSORB 520 (trade name, manufactured by KYODO CHEMICAL CO., LTD.), and ADKSTAB LA-32 (trade name, manufactured by ADEKA).

### <Release Agent>

To the heat-sensitive transfer image-receiving sheet of the present invention, a release agent may be added to secure a releasing property between the heat-sensitive transfer sheet and the heat-sensitive transfer image-receiving sheet at the time of image printing.

As the release agent, there can be used, for example, solid waxes such as polyethylene wax, paraffin wax, fatty acid ester wax, and amide wax; and silicone oil, phosphoric ester-based compounds, fluorine-based surfactants, silicone-based surfactants, and other release agents known in this technical field. Of these release agents, preferred are fatty acid ester waxes, fluorine-based surfactants, and silicone-based compounds such as silicone-based surfactants, silicone oil and/or hardened products thereof.

### <Surfactant>

Further in the heat-sensitive transfer image-receiving sheet of the present invention, a surfactant may be contained in any of such layers as described above. Of these layers, it is preferable to contain the surfactant in the receptor layer and the intermediate layer.

An addition amount of the surfactant is preferably from 0.01% by mass to 5% by mass, more preferably from 0.01% by mass to 1% by mass, and especially preferably from 0.02% by mass to 0.2% by mass, based on the total solid content.

With respect to the surfactant, various kinds of surfactants such as anionic, nonionic and cationic surfactants are known. As the surfactant that can be used in the present invention, any known surfactants may be used. For example, it is possible to use surfactants as reviewed in “Kinosei kaimenkasseizai (Functional Surfactants)”, editorial supervision of Mitsuo Tsunoda, edition on August in 2000, Chapter 6. Of these surfactants, fluorine-containing anionic surfactants are preferred.

### <Matting Agent>

To the heat-sensitive transfer image-receiving sheet of the present invention, a matting agent may be added in order to prevent blocking, or to give a release property or a sliding property. The matting agent may be added on the same side as the coating side of the receptor layer, or on the side opposite to the coating side of the receptor layer, or on both sides.

In the present invention, examples of the matting agent generally include fine particles of water-insoluble organic compounds and fine particles of water-insoluble inorganic compounds. In the present invention, the organic compound-containing fine particles are used from the viewpoints of dispersion properties. In so far as the organic compound is incorporated in the particles, there may be organic compound particles consisting of the organic compound alone, or alternatively organic/inorganic composite particles containing not only the organic compound but also an inorganic compound. As the matting agent, there can be used organic matting agents described in, for example, U.S. Pat. No. 1,939,213, No. 2,701,245, No. 2,322,037, No. 3,262,782, No. 3,539,344, and No. 3,767,448.

### <Antiseptic>

To the heat-sensitive transfer image-receiving sheet of the present invention, antiseptics may be added. The antiseptics that may be used in the image-receiving sheet of the invention are not particularly limited. For example, use can be made of materials described in Bofubokabi (Preservation and Antifungi) HAND BOOK, Gihodo shuppan (1986), Bokin Bokabi no Kagaku (Chemistry of Anti-bacteria and Anti-fungi) authored by Hiroshi Horiguchi, Sankyo Shuppan (1986), Bokin Bokabizai Jiten (Encyclopedia of Antibacterial and Antifungal Agent) edited by The Society for Antibacterial and Antifungal Agent, Japan (1986). Examples thereof include imidazole derivatives, sodium dehydroacetate, 4-isothiazoline-3-on derivatives, benzoisothiazoline-3-on, benzotriazole derivatives, amidineguanidine derivatives, quaternary ammonium salts, pyrrolidine, quinoline, guanidine derivatives, diazine, triazole derivatives, oxazole, oxazine derivatives, and 2-mercaptopyridine-N-oxide or its salt. Of these antiseptics, 4-isothiazoline-3-on derivatives and benzoisothiazoline-3-on are preferred.

The coating amount of the receptor layer is preferably 0.5 to 10 g/m² (solid basis, hereinafter, the amount to be applied in the present specification means a value on solid basis, unless otherwise specified). The film thickness of the receptor layer is preferably in the range of 1 μm to 20 μm.

### (Heat Insulation Layer)

The heat insulation layer that is coated in the heat-sensitive transfer image-receiving sheet of the present invention may be a single layer or double or more multiple layers. The heat insulation layer is disposed between the support and the receptor layer.

In the present invention, the heat insulation layer of the heat-sensitive transfer image-receiving sheet preferably contains hollow polymer particles, when the heat insulation layer is coated by aqueous coating method.

The hollow polymer particles in the present invention are polymer particles having voids inside of the particles. The hollow polymer particles are preferably hollow latex polymer of aqueous dispersion containing this hollow latex polymer. Examples of the hollow polymer particles include (1) non-foaming type hollow polymer particles obtained in the following manner: a dispersion medium such as water is contained inside of a capsule wall formed of a polystyrene, acrylic resin, or styrene/acrylic resin, and, after a coating liquid is applied and dried, the water in the particles is vaporized out of the particles, with the result that the inside of each particle forms a hollow; (2) foaming type microballoons obtained in the following manner: a low-boiling-point liquid such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling-point liquid inside of the particles, whereby the inside of each particle is made to be hollow; and (3) microballoons obtained by foaming the above (2) under heating in advance, to make hollow polymer particles.

Specific examples of the above (1) include Rohpake 1055, manufactured by Rohm and Haas Co.; Boncoat PP-1000, manufactured by Dainippon Ink and Chemicals, Incorporated; SX866(B), manufactured by JSR Corporation; and Nippol MH5055, manufactured by Nippon Zeon (all of these product names are trade names). Specific examples of the above (2) include F-30, and F-50, manufactured by Matsumoto Yushi-Seiyaku Co., Ltd. (all of these product names are trade names). Specific examples of the above (3) include F-30E, manufactured by Matsumoto Yushi-Seiyaku Co., Ltd, and Expancel 461DE, 551DE, and 551DE20, manufactured by Nippon Ferrite (all of these product names are trade names).

Of these, non-foaming hollow polymer particles of the foregoing (1) are preferred. If necessary, use can be made of a mixture of two or more kinds of polymer particles.

The average particle diameter (particle size) of the hollow polymer particles is preferably 0.1 to 5.0 μm, more preferably 0.2 to 3.0 μm, and particularly preferably 0.3 to 1.0 μm.

The hollow ratio (percentage of void) of the hollow polymer particles is preferably in the range of about 20% to about 70%, and particularly preferably from 20% to 50%.

In the present invention, the particle size of the hollow polymer particle is calculated after measurement of the circle-equivalent diameter of the periphery of particle under a transmission electron microscope. The average particle diameter is determined by measuring the circle-equivalent diameter of the periphery of at least 300 hollow polymer particles observed under the transmission electron microscope and obtaining the average thereof.

The hollow ratio of the hollow polymer particles is calculated by the ratio of the volume of voids to the volume of a particle.

The glass transition temperature (Tg) of the hollow polymer particles that can be used in the heat-sensitive transfer image-receiving sheet of the present invention is preferably 70 to 200° C., more preferably 90 to 180° C.

It is preferred that the heat insulation layer contains a water-soluble polymer as a binder in addition to hollow polymer particles. A preferable water-soluble polymer is exemplified by water-soluble polymers described in the section of Receptor layer. Among these water-soluble polymers, gelatin and a polyvinyl alcohol are more preferable. The solid content of the gelatin to the sum of the solid content of the hollow polymer particles and the solid content of the gelatin is preferably in the range of 10 mass % to 40 mass %, more preferably in the range of 14 mass % to 30 mass %. These resins may be used either singly or as a mixture thereof.

A thickness of the heat insulation layer containing the hollow polymer particles is preferably from 5 to 50 μm, more preferably from 5 to 40 μm.

### (Interlayer)

An interlayer may be formed between the receptive layer and the support. A function of the interlayer is exemplified by white background adjustment, antistatic, imparting of adhesion and imparting of smoothness (leveling). The function of the interlayer is not limited to these, and a previously known interlayer may be provided.

### <Support>

As the support that is used for the heat-sensitive transfer image-receiving sheet of the present invention, there may be used previously known supports with a preferable example being a water-proof support. The usage of the water-proof support enables to prevent the support from absorbing moisture thereto, so that a change in properties of the receptor layer with the lapse of time can be prevented. As the water-proof support, there may be, for example, a coat paper, a laminate paper and a synthetic paper. Of these, a laminate paper and a synthetic paper are preferable.

### <Curl Adjusting Layer>

In the heat-sensitive transfer image-receiving sheet that is used in the present invention, if necessary, a curl adjusting layer is preferably formed. For the curl adjusting layer, for example, a polyethylene laminate and a polypropylene laminate may be used. Specifically, the curl adjusting layer may be formed in the same manner as described in, for example, JP-A-61-110135 and JP-A-6-202295.

### <Writing Layer and Charge Controlling Layer>

In the heat-sensitive transfer image-receiving sheet that is used in the present invention, if necessary, a writing layer or a charge controlling layer may be disposed. For the writing layer and the charge control layer, an inorganic oxide colloid, an ionic polymer, or the like may be used. As the antistatic agent, any antistatic agents including cationic antistatic agents such as a quaternary ammonium salt and polyamine derivative, anionic antistatic agents such as alkyl phosphate, and nonionic antistatic agents such as fatty acid ester may be used. Specifically, the writing layer and the charge control layer may be formed in a manner similar to those described in the specification of Japanese Patent No. 3585585.

### <Method of Producing Heat-Sensitive Transfer Image-Receiving Sheet>

The method of producing the heat-sensitive transfer image-receiving sheet for use in the present invention is explained below.

In the present invention, the heat-sensitive transfer image-receiving sheet may be produced by the steps of forming each layer by a general coating method such as roll coating, bar coating, gravure coating, or gravure reverse coating and drying the coating.

In the method of producing the heat-sensitive transfer image-receiving sheet of the present invention, a receptor layer and a heat insulation layer are multilayer-coated simultaneously on a support.

It is known that in the case of producing a heat-sensitive transfer image-receiving sheet composed of plural layers having different functions from each other (for example, an air cell layer, a heat insulation layer, an intermediate layer, and a receptor layer) on a support, it may be produced by applying each layer successively one by one, or by overlapping the layers each already coated on the support, as shown in, for example, JP-A-2004-106283, JP-A-2004-181888 and JP-A-2004-345267. It has been known in photographic industries, on the other hand, that productivity can be greatly improved, for example, by providing plural layers through simultaneous multi-layer coating. For example, there are known methods, such as the so-called slide coating (slide coating method) and curtain coating (curtain coating method), as described in, for example, U.S. Pat. Nos. 2,761,791, 2,681,234, 3,508,947, 4,457,256 and 3,993,019; JP-A-63-54975, JP-A-61-278848, JP-A-55-86557, JP-A-52-31727, JP-A-55-142565, JP-A-50-43140, JP-A-63-80872, JP-A-54-54020, JP-A-5-104061, JP-A-5-127305, and JP-B-49-7050 (“JP-B” means examined Japanese patent publication); and Edgar B. Gutoff, et al., “Coating and Drying Defects: Troubleshooting Operating Problems”, John Wiley & Sons, 1995, pp. 101-103.

In the present invention, the productivity is greatly improved and, at the same time, image defects can be remarkably reduced, by using the above simultaneous multilayer coating for the production of an image-receiving sheet having a multilayer structure.

### <Image-Forming>

In the image-forming method (system) of the present invention, imaging is achieved by superposing a heat-sensitive transfer sheet on a heat-sensitive transfer image-receiving sheet so that a heat transfer layer of the heat-sensitive transfer sheet is in contact with a receptor layer of the heat-sensitive transfer image-receiving sheet and giving thermal energy in accordance with image signals given from a thermal head.

Specifically, image-forming can be achieved by the similar manner to that as described in, for example, JP-A-2005-88545. In the present invention, a printing time is preferably less than 15 seconds, and more preferably in the range of 3 to 12 seconds, and further preferably 3 to 7 seconds, from the viewpoint of shortening a time taken until a consumer gets a print.

In order to accomplish the above-described printing time, a line speed at the time of printing is preferably 0.73 msec/line or less, and further preferably 0.65 msec/line or less. Further, from the viewpoint of improvement in transfer efficiency under speeding-up conditions, the maximum ultimate temperature of the thermal head at the time of printing is preferably in the range of 180° C. to 450° C., more preferably from 200° C. to 450° C., and furthermore preferably from 350° C. to 450° C.

The method of the present invention may be utilized for printers, copying machines and the like, which employs a heat-sensitive transfer recording system. As a means for providing heat energy in the thermal transfer, any of the conventionally known providing means may be used. For example, application of a heat energy of about 5 to 100 mJ/mm² by controlling recording time in a recording device such as a thermal printer (e.g., trade name: Video Printer VY-100, manufactured by Hitachi, Ltd.), sufficiently attains the expected result. Further, the heat-sensitive transfer image-receiving sheet for use in the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

The present invention can provide a method of forming an image that provides with sublimation printing that can achieve both high density and good color balance particularly after high temperature storage in dark place for certain period of time.

The present invention will be described in more detail based on the following examples, but the invention is not intended to be limited thereto. In the following Examples, the terms “part” and “%” are values by mass, unless they are indicated differently in particular.

### EXAMPLES

### Example 1

### (Production of Heat-Sensitive Transfer Sheets)

A polyester film 6.0 μm in thickness (trade name: Diafoil K200E-6F, manufactured by MITSUBISHI POLYESTER FILM CORPORATION), that was subjected to an easy-adhesion-treatment on one surface of the film, was used as a support. The following back side-layer coating liquid was applied onto the support on the other surface that was not subjected to the easy-adhesion-treatment, so that the coating amount based on the solid content after drying would be 1 g/m². After drying, the coating liquid was cured by heat at 60° C.

Coating liquids, which will be detailed later, were used to form, onto the easily-adhesive layer painted surface of the thus-formed polyester film, individual heat-sensitive transfer layers in yellow, magenta and cyan, and a transferable protective layer laminate in area order by painting. In this way, a heat-sensitive transfer sheet was produced. The solid coating amount in each of the heat-sensitive transfer layers (dye layers) was set to 0.8 g/m².

In the formation of the transferable protective layer laminate, a releasing-layer-coating liquid was painted, a protective-layer-coating liquid was painted thereon, the resultant was dried, and then an adhesive-layer-coating liquid was painted thereon.

### Back Side Layer-Coating Liquid

| | | |
|---|---|---|
| Acrylic polyol resin | 26.0 | mass parts |
| (trade name: ACRYDIC A-801, manufactured by | | |
| Dainippon Ink and Chemicals, Incorporated) | | |
| Zinc stearate | 0.43 | mass part |
| (trade name: SZ-2000, manufactured by Sakai | | |
| Chemical Industry Co., Ltd.) | | |
| Phosphate ester | 1.27 | mass parts |
| (trade name: PLYSURF A217, manufactured by Dai- | | |
| ichi Kogyo Seiyaku Co., Ltd.) | | |
| Isocyanate (50% solution) | 8.0 | mass parts |
| (trade name: BURNOCK D-800, manufactured by | | |
| Dainippon Ink and Chemicals, Incorporated) | | |
| Methyl ethyl ketone/Toluene (2/1, at mass ratio) | 64 | mass parts |

Ink sheets 1 to 12 were prepared using the basic composition for each of yellow, magenta and cyan dye coating liquids shown below together with different combinations of Y, M and C dyes as shown in the table below.

### Yellow-Dye-Layer-Coating Liquid

| | | |
|---|---|---|
| Y dye | 7.8 | mass parts |
| Polyvinylacetal resin | 8.2 | mass parts |
| (trade name: ESLEC KS-1, manufactured by | | |
| Sekisui Chemical Co., Ltd.) | | |
| Release agent | 0.05 | mass part |
| (trade name: X-22-3000T, manufactured by Shin-Etsu | | |
| Chemical Co., Ltd.) | | |
| Release agent | 0.03 | mass part |
| (trade name: TSF4701, manufactured by | | |
| MOMENTIVE Performance Materials Japan LLC.) | | |
| Matting agent | 0.15 | mass part |
| (trade name: Flo-thene UF, manufactured by | | |
| Sumitomo Seika Chemicals Co., Ltd.) | | |
| Methyl ethyl ketone/Toluene (2/1, at mass ratio) | 84 | mass parts |

### Magenta-Dye-Layer-Coating Liquid

| | | |
|---|---|---|
| M dye | 7.8 | mass parts |
| Polyvinylacetal resin | 8.2 | mass parts |
| (trade name: ESLEC KS-1, manufactured by | | |
| Sekisui Chemical Co., Ltd.) | | |
| Release agent | 0.05 | mass part |
| (trade name: X-22-3000T, manufactured by Shin-Etsu | | |
| Chemical Co., Ltd.) | | |
| Release agent | 0.03 | mass part |
| (trade name: TSF4701, manufactured by | | |
| MOMENTIVE Performance Materials Japan LLC.) | | |
| Matting agent | 0.15 | mass part |
| (trade name: Flo-thene UF, manufactured by | | |
| Sumitomo Seika Chemicals Co., Ltd.) | | |
| Methyl ethyl ketone/Toluene (2/1, at mass ratio) | 84 | mass parts |

### Cyan-Dye-Layer-Coating Liquid

| | | |
|---|---|---|
| C dye | 7.8 | mass parts |
| Polyvinylacetal resin | 8.2 | mass parts |
| (trade name: ESLEC KS-1, manufactured by | | |
| Sekisui Chemical Co., Ltd.) | | |
| Release agent | 0.05 | mass part |
| (trade name: X-22-3000T, manufactured by Shin-Etsu | | |
| Chemical Co., Ltd.) | | |
| Release agent | 0.03 | mass part |
| (trade name: TSF4701, manufactured by | | |
| MOMENTIVE Performance Materials Japan LLC.) | | |
| Matting agent | 0.15 | mass part |
| (trade name: Flo-thene UF, manufactured by | | |
| Sumitomo Seika Chemicals Co., Ltd.) | | |
| Methyl ethyl ketone/Toluene (2/1, at mass ratio) | 84 | mass parts |

On the same polyester film as used in the preparation of the dye layers as described above, coating liquids of a releasing layer, a protective layer and an adhesive layer each having the following composition was coated, to form a transferable protective layer laminate. Coating amounts of the releasing layer, the protective layer and the adhesive layer after drying were 0.3 g/m², 0.5 g/m² and 2.2 g/m², respectively.

### Releasing-Layer-Coating Liquid

| | |
|---|---|
| Modified cellulose resin | 5.0 mass parts |
| (trade name: L-30, manufactured by DAICEL | |
| CHEMICAL INDUSTRIES, LTD.) | |
| Methyl ethyl ketone | 95.0 mass parts |

### Protective-Layer-Coating Liquid

| | |
|---|---|
| Acrylic resin solution (Solid content: 40%) | 90 mass parts |
| (trade name: UNO-1, manufactured by Gifu Ceramics | |
| Limited) | |
| Methanol/Isopropanol (1/1, at mass ratio) | 10 mass parts |

### Adhesive-Layer-Coating Liquid

| | |
|---|---|
| Acrylic resin | 25 mass parts |
| (trade name: DIANAL BR-77, manufactured by | |
| MITSUBISHI RAYON CO., | |
| LTD.) | |
| The following ultraviolet absorbent UV-1 | 2 mass parts |
| The following ultraviolet absorbent UV-2 | 1 mass part |
| The following ultraviolet absorbent UV-3 | 1 mass part |
| The following ultraviolet absorbent UV-4 | 1 mass part |
| PMMA fine particles (polymethyl methacrylate fine | 0.4 mass part |
| particles) | |
| Methyl ethyl ketone/Toluene (2/1, at mass ratio) | 70 mass parts |

(UV-1)

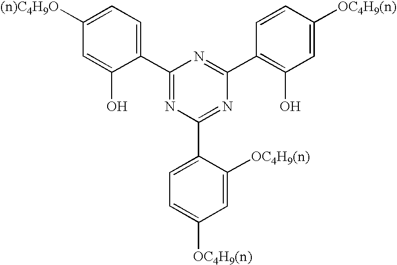

(UV-2)

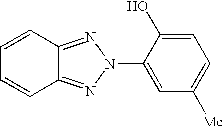

(UV-3)

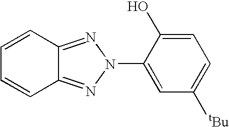

(UV-4)

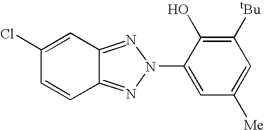

In this process, each of the dyes shown below was used for each of heat-sensitive transfer sheets 1 to 12. In addition, in the preparation of the heat-sensitive transfer sheet 12, Macrolex Yellow 6G (manufactured by BAYER), Disperse Red 60 and Solvent Blue 63 were used as Y dye, M dye and C dye, respectively.

TABLE 4

| Heat-sensitive | | | |
|---|---|---|---|
| transfer | | | |
| sheet No. | Y dye | M dye | C dye |
| 1 | Compound Y-5 | Exemplified | Exemplified |
| | | compound 2-1 | compound 3-1 |
| 2 | Compound Y-6 | Exemplified | Exemplified |
| | | compound 2-1 | compound 3-1 |
| 3 | Exemplified | Exemplified | Exemplified |
| | compound 1-1 | compound 2-1 | compound 3-1 |
| 4 | Exemplified | Exemplified | Exemplified |
| | compound 1-1 | compound 2-2 | compound 3-2 |
| 5 | Exemplified | Exemplified | Exemplified |
| | compound 1-1 | compound 2-3 | compound 3-3 |
| 6 | Exemplified | Exemplified | Exemplified |
| | compound 1-2 | compound 2-1 | compound 3-1 |
| 7 | Exemplified | Exemplified | Exemplified |
| | compound 1-2 | compound 2-2 | compound 3-2 |
| 8 | Exemplified | Exemplified | Exemplified |
| | compound 1-2 | compound 2-3 | compound 3-3 |
| 9 | Exemplified | Exemplified | Exemplified |
| | compound 1-3 | compound 2-1 | compound 3-1 |
| 10 | Exemplified | Exemplified | Exemplified |
| | compound 1-3 | compound 2-2 | compound 3-2 |
| 11 | Exemplified | Exemplified | Exemplified |
| | compound 1-3 | compound 2-3 | compound 3-3 |
| 12 | Macrolex Yellow | Disperse Red 60 | Solvent Blue 63 |
| | 6G | | |

Compounds Y-5 and Y-6 are shown below, respectively.

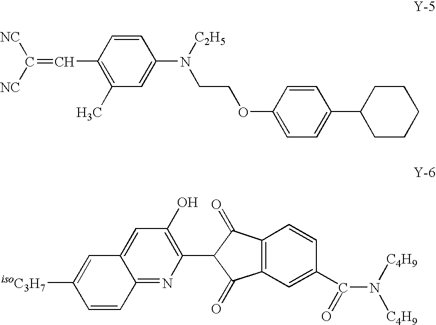

### (Preparation of Heat-Sensitive Transfer Image-Receiving Sheets)

A paper support, on both sides of which polyethylene was laminated, was subjected to corona discharge treatment on the surface thereof, and then a gelatin undercoat layer containing sodium dodecylbenzenesulfonate was disposed on the treated surface. A subbing layer, a heat insulation layer, a lower receptor layer and an upper receptor layer each having the following composition were simultaneously multilayer-coated on the gelatin undercoat layer, in the state that the subbing layer, the heat insulation layer, the lower receptor layer and the upper receptor layer were laminated in this order from the side of the support, by a method illustrated in FIG. 9 in U.S. Pat. No. 2,761,791. The coating was performed so that coating amounts of the subbing layer, the heat insulation layer, the lower receptor layer, and the upper receptor layer after drying would be 6.7 g/m², 8.7 g/m², 2.6 g/m² and 2.7 g/m², respectively. The following compositions are expressed by mass as a solid content.

### Preparation of Heat-Sensitive Transfer Image-Receiving Sheet 1

### Upper Receptor Layer

| | | |
|---|---|---|
| Vinyl chloride-series latex | 22.0 | mass parts |
| (trade name: BINYBLAN 900, manufactured by | | |
| Nisshin Chemicals Co., Ltd.) | | |
| Vinyl chloride-series latex | 2.4 | mass parts |
| (trade name: VINIBLAN 276, manufactured by | | |
| Nisshin Chemicals Co., Ltd.) | | |
| Gelatin (10% solution) | 2.0 | mass parts |
| The following ester-series wax EW-1 | 2.0 | mass parts |
| The following surfactant F-1 | 0.07 | mass part |
| The following surfactant F-2 | 0.36 | mass part |

### Lower Receptor Layer

| | | |
|---|---|---|
| Vinyl chloride-series latex | 12.0 | mass parts |
| (trade name: VINIBLAN 690, manufactured by | | |
| Nisshin Chemicals Co., Ltd.) | | |
| Vinyl chloride-series latex | 12.0 | mass parts |
| (trade name: VINIBLAN 900, manufactured by | | |
| Nisshin Chemicals Co., Ltd.) | | |
| Gelatin (10% solution) | 10.0 | mass parts |
| The following surfactant F-1 | 0.04 | mass part |

### Heat Insulation Layer

| | |
|---|---|
| Hollow latex polymer particles | 60.0 mass parts |
| (trade name: MH5055, manufactured by Nippon Zeon | |
| Co., Ltd.) | |
| Gelatin (10% solution) | 30.0 mass parts |

### Subbing Layer

| | |
|---|---|
| Polyvinyl alcohol | 6.7 mass parts |
| (trade name: POVAL PVA 205, manufactured by | |
| Kuraray) | |
| Styrene butadiene rubber latex | 60.0 mass parts |
| (trade name: SN-307, manufactured by NIPPON A & L | |
| INC) | |
| The following surfactant F-1 | 0.03 mass part |

(EW-1)

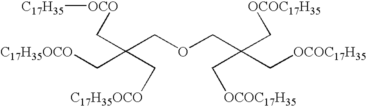

(F-1)

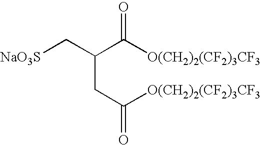

F-2

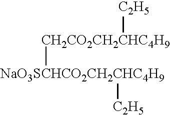

### Preparation of Heat-sensitive Transfer Image-Receiving Sheet 2

Heat-sensitive transfer image-receiving sheet 2 was prepared in the same manner as the heat-sensitive transfer image-receiving sheet 1, except that a sheet of synthetic paper (Yupo FPG200 (trade name), 200 μm in thickness, manufactured by Yupo Corporation) was used as the support and that the upper and lower receptor layers of the heat-sensitive transfer image-receiving sheet 1 were replaced with the layers each having the composition shown below.

### Upper Receptor Layer

| | | |
|---|---|---|
| Vinyl chloride-series latex | 24.4 | mass parts |
| (trade name: VINIBLAN 690, manufactured by | | |
| Nisshin Chemicals Co., Ltd.) | | |
| Gelatin (10% solution) | 2.0 | mass parts |
| Ester-series wax EW-1 | 2.0 | mass parts |
| Surfactant F-1 | 0.07 | mass part |
| Surfactant F-2 | 0.36 | mass part |

### Lower Receptor Layer

| | | |
|---|---|---|
| Vinyl chloride-series latex | 24.0 | mass parts |
| (trade name: VINIBLAN 690, manufactured by | | |
| Nisshin Chemicals Co., Ltd.) | | |
| Gelatin (10% solution) | 10.0 | mass parts |
| Surfactant F-1 | 0.04 | mass part |

### Preparation of Heat-Sensitive Transfer Image-Receiving Sheet 3

A synthetic paper (trade name: Yupo FPG 200, manufactured by Yupo Corporation, thickness: 200 μm) was used as the support; and, on one surface of the support, a white intermediate layer and a receptor layer, having the following compositions, were coated in this order by a bar coater. The coating was carried out such that the amount of the white intermediate layer and the amount of the receptor layer after each layer was dried would be 1.0 g/m² and 4.0 g/m², respectively, and these layers were respectively dried at 110° C. for 30 seconds.

### White Intermediate Layer

| | |
|---|---|
| Polyester resin | 10 mass parts |
| (trade name: Vylon 200, manufactured by Toyobo Co., | |
| Ltd.) | |
| Fluorescent whitening agent | 1 mass part |
| (trade name: Uvitex OB, manufactured by Ciba-Geigy) | |
| Titanium oxide | 30 mass parts |
| Methyl ethyl ketone/Toluene (1/1, at mass ratio) | 90 mass parts |

### Receptor Layer

| | |
|---|---|
| Vinyl chloride/vinyl acetate resin | 100 mass parts |
| (trade name: Solbin A, manufactured by Nisshin | |
| Chemicals Co., Ltd.) | |
| Amino-modified silicone | 5 mass parts |
| (trade name: X22-3050C, manufactured by Shin-Etsu | |
| Chemical Co., Ltd.) | |
| Epoxy-modified silicone | 5 mass parts |
| (trade name: X22-3000E, manufactured by Shin- | |
| Etsu Chemical Co., Ltd.) | |
| Methyl ethyl ketone/toluene (1/1, at mass ratio) | 400 mass parts |

### (Image Formation)

An image with a size of 152 mm×102 mm was output using the above-described heat-sensitive transfer sheets 1 to 11 and heat-sensitive transfer image-receiving sheets 1 to 3 as shown in Table 5, by means of a thermal transfer type printer A (ASK-2000, manufactured by FUJIFILM Corporation). Herein, a traveling rate of the thermal transfer type printer A was 0.70 msec/line.

### (Evaluation of Transfer Density After Storage at High Temperature in Dark Place for Time Period)

An entirely black image was output and printed. The print was stored for 14 days in an 80° C. dry dark place of Thermocellco (without humidification) and measured for reflection density with X-rite 310 (trade name, manufactured by X-rite Incorporated), and then evaluated according the following criteria.

### (Evaluation of Density: Index Dv)

V density (visual density) value of the reflection density after the above elapsed time was expressed as Dv and used as an index for evaluation.

### (Evaluation of Color Balance: Index CB)

The difference between the yellow density (Y density) and the magenta density (M density) of the reflection density after the above elapsed time was used as an index of color balance (CB).

### (Index P)

Dv and CB determined as described above were used to define an index P for evaluation after the above elapsed time, which was calculated according to the formula: P=(Dv)²/CB. The larger P value may be evaluated as better after the storage at the high temperature in dark place for the time period (the better color fading balance between the respective Y, M and C densities with less degradation of each dye). In this case, a P value of 12 or more was determined as good.

These results are summarized in Table 5 below.

TABLE 5

| | | Heat-sensitive | | | |
|---|---|---|---|---|---|
| | Heat-sensitive | transfer image- | V Density | Color | |
| | transfer sheet | receiving sheet | (Dv) | Balance (CB) | Index P |
| Comparative example 1 | 1 | 1 | 1.645 | 0.324 | 8.4 |
| Comparative example 2 | 1 | 2 | 1.79 | 0.298 | 10.8 |
| Comparative example 3 | 1 | 3 | 1.233 | 0.14 | 10.9 |
| Comparative example 4 | 2 | 1 | 1.65 | 0.631 | 4.3 |
| Comparative example 5 | 2 | 2 | 1.764 | 0.658 | 4.7 |
| Comparative example 6 | 2 | 3 | 1.164 | 0.227 | 6 |
| This invention 1 | 3 | 1 | 1.665 | 0.194 | 14.3 |
| This invention 2 | 3 | 2 | 1.79 | 0.193 | 16.6 |
| Comparative example 7 | 3 | 3 | 1.204 | 0.143 | 10.1 |
| This invention 3 | 4 | 1 | 1.583 | 0.204 | 12.3 |
| This invention 4 | 4 | 2 | 1.596 | 0.201 | 12.7 |
| Comparative example 8 | 4 | 3 | 1.083 | 0.251 | 4.7 |
| This invention 5 | 5 | 1 | 1.634 | 0.198 | 13.5 |
| This invention 6 | 5 | 2 | 1.647 | 0.195 | 13.9 |
| Comparative example 9 | 5 | 3 | 1.13 | 0.259 | 4.9 |
| This invention 7 | 6 | 1 | 1.584 | 0.195 | 12.9 |
| This invention 8 | 6 | 2 | 1.585 | 0.197 | 12.8 |
| Comparative example 10 | 6 | 3 | 1.119 | 0.313 | 4 |
| This invention 9 | 7 | 1 | 1.596 | 0.2 | 12.7 |
| This invention 10 | 7 | 2 | 1.639 | 0.201 | 13.4 |
| Comparative example 11 | 7 | 3 | 1.076 | 0.304 | 3.8 |
| This invention 11 | 8 | 1 | 1.627 | 0.2 | 13.2 |
| This invention 12 | 8 | 2 | 1.597 | 0.203 | 12.6 |
| Comparative example 12 | 8 | 3 | 1.087 | 0.228 | 5.2 |
| This invention 13 | 9 | 1 | 1.654 | 0.196 | 14 |
| This invention 14 | 9 | 2 | 1.623 | 0.195 | 13.5 |
| Comparative example 13 | 9 | 3 | 1.143 | 0.234 | 5.6 |
| This invention 15 | 10 | 1 | 1.589 | 0.198 | 12.8 |
| This invention 16 | 10 | 2 | 1.604 | 0.196 | 13.1 |
| Comparative example 14 | 10 | 3 | 1.119 | 0.267 | 4.7 |
| This invention 17 | 11 | 1 | 1.646 | 0.202 | 13.4 |
| This invention 18 | 11 | 2 | 1.643 | 0.202 | 13.3 |
| Comparative example 15 | 11 | 3 | 1.094 | 0.287 | 4.2 |
| Comparative example 16 | 12 | 1 | 1.020 | 0.110 | 9.5 |

A comparison between each sample according to the present invention and each sample of Comparative Example shows that according to the present invention, there is provided sublimation printing that can achieve both high density and good color balance after storage under high temperature in the dark place.

Much better result was obtained when another experiment was performed using the same combinations as shown in the table 5 at the line speed of 0.65 msec/line with another printer.

Having described our invention as related to the present embodiments, it is our intention that the present invention not be limited by any of the details of the description, unless otherwise specified, but rather be construed broadly within its spirit and scope as set out in the accompanying claims.

This non-provisional application claims priority under 35 U.S.C. §119(a) on Patent Application No. 2007-339892 filed in Japan on Dec. 28, 2007, which is entirely herein incorporated by reference.

What is claimed is:

1. A method of producing an image, comprising the steps of:
superposing a heat-sensitive transfer sheet on a heat-sensitive transfer image-receiving sheet so that a heat-sensitive transfer layer of the heat-sensitive transfer sheet is in contact with a receptor layer of the heat-sensitive transfer image-receiving sheet, and
applying thermal energy in accordance with an image signal, to form a thermally transferred image,
wherein the heat-sensitive transfer sheet comprises, on a support, a yellow dye layer which contains at least one kind of yellow dye represented by formula (1), a magenta dye layer which contains at least one kind of magenta dye represented by formula (2), and a cyan dye layer which contains at least one kind of cyan dye represented by formula (3); and
wherein the receptor layer on a support of the heat-sensitive transfer image-receiving sheet contains a latex polymer; 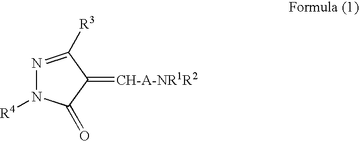
wherein A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted alkyl group, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group; 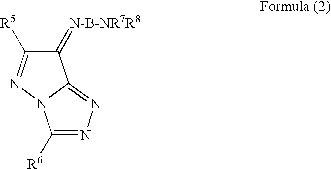
wherein B represents a substituted or unsubstituted phenylene group or a substituted or unsubstituted divalent pyridine ring group; and R⁵, R⁶, R⁷ and R⁸ each independently represent a substituted or unsubstituted alkyl group, a substituted or unsubstituted alkenyl group or a substituted or unsubstituted aryl group; and 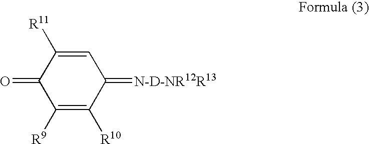
wherein D represents a substituted or unsubstituted phenylene group; R⁹ represents a hydrogen atom or a halogen atom; R¹⁰ represents a substituted or unsubstituted alkyl group; R¹¹ represents a substituted or unsubstituted acylamino group or a substituted or unsubstituted alkoxycarbonylamino group; and R¹² and R¹³ each independently represent a substituted or unsubstituted alkyl group, a substituted or unsubstituted alkenyl group or a substituted or unsubstituted aryl group.

2. The method of producing an image according to claim 1, wherein the heat-sensitive transfer image-receiving sheet further comprises at least one heat insulation layer that contains hollow polymer particles between the support and the receptor layer.

3. The method of producing an image according to claim 2, wherein the hollow polymer particles are latex hollow polymer particles.

4. The method of producing an image according to claim 2, wherein the heat insulation layer and the receptor layer of the heat-sensitive transfer image-receiving sheet are formed by simultaneous multilayer coating.

5. The method of producing an image according to claim 1, wherein R¹, R², R⁷, R⁸, R¹² and R¹³ each independently represent an unsubstituted alkyl group; R³ represents an unsubstituted alkoxy group; R⁴ represents an unsubstituted aryl group; R⁵ represents a substituted or unsubstituted alkyl group; R⁶ represents a substituted or unsubstituted aryl group; R⁹ represents a halogen atom; R¹⁰ represents an unsubstituted alkyl group; R¹¹ represents an unsubstituted acyl group; A represents an unsubstituted phenylene group; B represents a substituted or unsubstituted divalent pyridine ring group; and D represents an unsubstituted phenylene group.

6. The method of producing an image according to claim 1,
wherein the heat-sensitive transfer sheet further comprises a back side layer on the surface of the support opposite to the yellow, magenta and cyan dye layers, and
wherein the back side layer comprises an acrylic resin.

7. The method of producing an image according to claim 6, wherein the acrylic resin of the back side layer is an acrylic polyol resin.

8. The method of producing an image according to claim 1, wherein each of the dye layers comprises a matting agent.

9. The method of producing an image according to claim 1,
wherein the receptor layer comprises at least two kinds of latex polymers, and
wherein each of the two kinds of the latex polymers is a polyvinylchloride series latex polymer.
